(19) United States
(12) Patent Application Publication
(10) Pub. No.: US 2015/0249585 A1
(43) Pub. Date: Sep. 3, 2015

(54) DETECTION APPARATUS, DETECTION METHOD, AND DETECTION PROGRAM

(71) Applicant: Hitachi, Ltd., Tokyo (JP)

(72) Inventors: Yusuke SHOMURA, Tokyo (JP); Seishi HANAOKA, Tokyo (JP)

(73) Assignee: HITACHI, LTD., Tokyo (JP)

(21) Appl. No.: 14/637,326

(22) Filed: Mar. 3, 2015

(30) Foreign Application Priority Data
Mar. 3, 2014 (JP) 2014-040384

(51) Int. Cl. H04L 12/26; H04L 29/08

(52) U.S. Cl. CPC H04L 43/08; H04L 67/02

(57) ABSTRACT

It is provided a detection apparatus including: a first storage module configured to store logs about traffic between communication apparatus and, when a consumed storage capacity reaches a given level or higher, delete the stored logs starting from an oldest log; a calculation module configured to refer to specific logs about specific traffic that is related to a subject of communication quality monitoring from the logs stored in the first storage module, thereby calculating a group of time-series statistical values about communication quality of the monitoring subject; a detection module configured to compare the group of time-series statistical values with a threshold, thereby detecting communication quality deterioration of the monitoring subject; and a saving module configured to obtain, when communication quality deterioration of the monitoring subject is detected, the specific logs from the first storage module and store the specific logs in a second storage module.

### CLAIM OF PRIORITY

The present application claims priority from Japanese patent application JP 2014-40384 filed on Mar. 3, 2014, the content of which is hereby incorporated by reference into this application.

### BACKGROUND

This invention relates to a detection apparatus, a detection method, and a detection program, which are configured to detect deterioration in communication quality.

The related art of this invention includes a statistics information processing system which deduces out-of-range areas and areas where channel capacity is in short supply (see, for example, JP 09-261159 A). In JP 09-261159 A, portable terminal statistics information is recorded in each portable terminal while the terminal is powered on. The portable terminal statistics information includes identification information of a (wireless) base station whose signal the terminal has waited for, the length of time in which the terminal has been out of range, and a success/failure at capturing a channel in position registration/call sending and receiving. In this state, each time the position of the terminal is registered, the statistics information processing system deduces out-of-range areas and channel capacity shortage areas as poor communication quality areas based on the portable terminal statistics information that is transferred from the terminal via a base station.

The related art also includes a communication quality management system which evaluates the scale of quality deterioration in terms of the count of affected terminals and deduces the cause of quality deterioration while keeping the storage capacity necessary to execute the evaluation and the deduction small (see, for example, JP 2010-109744 A). In JP 2010-109744 A, detection means detects an attempt at communication and a failure at communication within a communication area. When the detection means detects an attempt at communication and a failure at communication, communication information registering means compiles period communication information based on the count of communication attempts and the count of communication failures, and registers the compiled information in communication information storing means. Management subject terminal identifying means identifies a mobile terminal whose failure at communication has been detected by the detection means as a management subject terminal, which is a subject of communication quality calculation. Compiled terminal information registering means compiles terminal failure information for each management subject terminal identified by the management subject terminal identifying means, and registers the compiled information in the communication information storing means.

Also included in the related art is a wireless apparatus which identifies the cause of a failure in a wireless link to a wireless base station at the other end, and takes countermeasures (see, for example, JP 2012-74765 A). In JP 2012-74765 A, the wireless apparatus includes a statistics information obtaining unit for obtaining a characteristics value of statistics information which indicates the state of a wireless link, a failure cause detecting unit for detecting, based on the characteristics value, in a given order, a plurality of failure causes associated in advance with the statistics information, and a countermeasure executing unit for executing countermeasures that are associated in advance with the failure causes detected by the failure cause detecting unit. The plurality of failure causes include the presence of shadowing and the presence of radio noise, and detecting the failure causes in a given order means detecting the presence of radio noise after detecting the presence of shadowing.

Another technology included in the related art is a wireless station that is coupled to another wireless station via a wireless link and identifies the cause of a failure in the wireless link (see, for example, WO 2011/030466 A1). In WO 2011/030466 A1, the wireless station includes a wireless link control unit for executing wireless link control of the wireless link by following a wireless link control method, a statistics information obtaining unit for obtaining statistics information which indicates the state of the wireless link while the wireless link control is executed, and a failure cause identifying unit for, identifying the cause of a failure in the wireless link from among a plurality of failure causes associated in advance with the statistics information, based on the statistics information obtained by the statistics information obtaining unit.

Catching signs of quality deterioration with precision requires detailed information about traffic such as a log. On the other hand, an increase in traffic volume leads to an increase in the amount of data accumulated for the analysis of the cause of deterioration. With the related art described above, however, the data amount cannot be reduced and a storage area of large capacity is needed to save data for a long term.

### SUMMARY

The disclosure enables to reduce the storage capacity necessary for the analysis of the cause of deterioration.

An aspect of the disclosure in this application is a detection apparatus, including: a first storage module configured to store logs about traffic between communication apparatus and, when a consumed storage capacity reaches a given level or higher, delete the stored logs starting from an oldest log; a calculation module configured to refer to specific logs about specific traffic that is related to a subject of communication quality monitoring out of the logs stored in the first storage module, thereby calculating a group of time-series statistical values about communication quality of the monitoring subject; a detection module configured to compare the group of time-series statistical values calculated by the calculation module with a threshold for communication quality deterioration of the monitoring subject, thereby detecting communication quality deterioration of the monitoring subject; and a saving module configured to obtain, when communication quality deterioration of the monitoring subject is detected by the detection module, the specific logs from the first storage module and store the specific logs in a second storage module.

According to the exemplary embodiment of the disclosure, the storage capacity necessary for the analysis of the cause of deterioration can be reduced.

### BRIEF DESCRIPTION OF THE DRAWINGS

FIG. 1 is an explanatory diagram for illustrating an example of identifying the cause of quality deterioration according to this embodiment.

FIG. 2 is an explanatory diagram for illustrating a configuration example of a network that includes the detection apparatus according to this embodiment.

FIG. 3 is a block diagram illustrating a hardware configuration example of the detection apparatus.

FIG. 4 is a block diagram illustrating a functional configuration example of the detection apparatus.

FIG. 5 is an explanatory diagram for illustrating an example of what is stored in the TCP/UDP log table.

FIG. 6 is an explanatory diagram for illustrating an example of what is stored in the HTTP log table.

FIG. 7 is an explanatory diagram for illustrating an example of what is stored in the control message log table.

FIG. 8 is an explanatory diagram for illustrating an example of the packet data group.

FIG. 9 is an explanatory diagram for illustrating an example of the distribution information.

FIG. 10 is an explanatory diagram for illustrating an example of what is stored in the quality information table.

FIG. 11A is a graph showing changes with time of the terminal in QoE value.

FIG. 11B is a graph showing changes with time of the terminal in QoE value.

FIG. 11C is a graph showing changes with time of the deterioration event count.

FIG. 11D is a graph showing changes with time in the volume of traffic to the MME.

FIG. 11E is a graph showing changes with time in the volume of traffic to the MME.

FIG. 12 is an explanatory diagram for illustrating the control data which is generated by the detection module.

FIG. 13A is an explanatory diagram for illustrating an example of how the acquisition period of FIG. 12 is determined.

FIG. 13B is an explanatory diagram for illustrating an example of how the acquisition period of FIG. 12 is determined.

FIG. 13C is an explanatory diagram for illustrating an example of how the acquisition period of FIG. 12 is determined.

FIG. 13D is an explanatory diagram for illustrating an example of how the acquisition period of FIG. 12 is determined.

FIG. 14A is an explanatory diagram for illustrating an example of determining the acquisition period in the case where deterioration is detected by the method of FIG. 11C.

FIG. 14B is an explanatory diagram for illustrating an example of determining the acquisition period in the case where deterioration is detected by the method of FIG. 11C.

FIG. 15 is a flow chart illustrating an example of reference value DB creating processing, which is executed by the creation module.

FIG. 16 is a flow chart illustrating Example 1 of processing of creating the quality information table which is executed by the calculation module.

FIG. 17 is a flow chart illustrating an example of the QoE value calculating processing of FIG. 16 (Step S1604).

FIG. 18 is a flow chart illustrating Example 2 of processing of creating the quality information table which is executed by the calculation module.

FIG. 19 is a flow chart illustrating an example of deterioration detecting processing, which is executed by the detection module.

FIG. 20 is a flow chart illustrating an example of storage processing, which is executed by the saving module.

### DETAILED DESCRIPTION OF THE PREFERRED EMBODIMENT

### Example of Quality Deterioration Cause Identification

A detection apparatus according to an embodiment has, for example, a round robin database (RRD) in the upstream to accumulate a given amount of data and to erase the accumulated data starting from the oldest data when the given amount is exceeded, and an accumulation database (DB) in the downstream to save data that is to be analyzed. The RRD erases the oldest data in a given period of time (e.g., a month), whereas the accumulation DB keeps data for a period (e.g., a year) longer than the retention period of the RRD. In other words, by evacuating data that is related to a deterioration cause from the RRD to the accumulation DB, data that would normally be deleted from the RRD with the elapse of time can be saved in the accumulation DB, and longer-tem data retention than in the RRD is accomplished.

The detection apparatus receives a log about traffic and traffic which are obtained by a Deep Packet Inspection (DPI) apparatus, and saves the log and the traffic in the RRD. Of the log and traffic saved in the RRD, portions that correspond to quality deterioration are saved in the accumulation DB. The log and the traffic that are saved in the accumulation DB can be used for the analysis of the cause of a failure. In this embodiment, the storage capacity of the accumulation DB can be reduced by reducing the data amount of the log and the traffic that are saved in the accumulation DB.

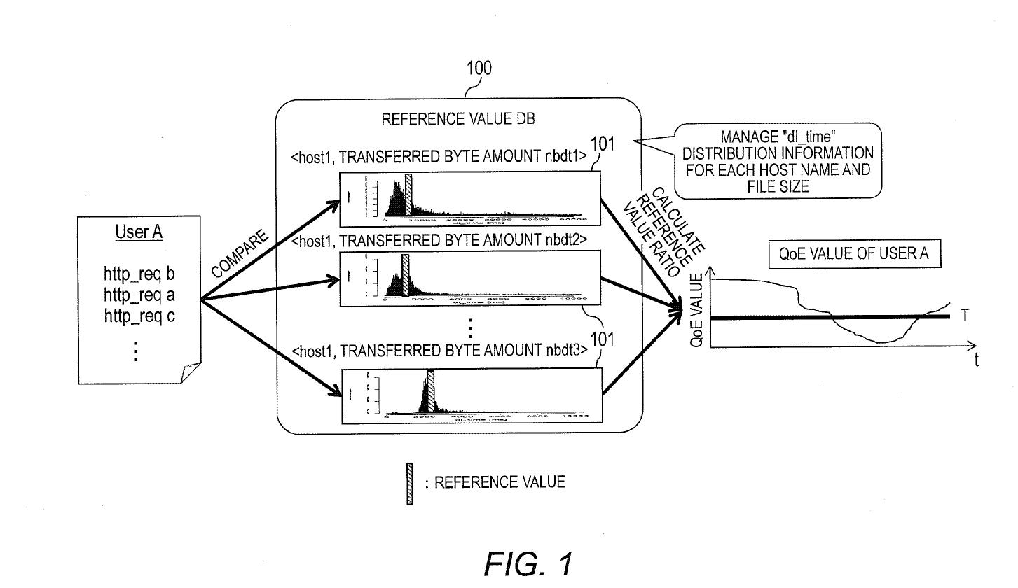

FIG. 1 is an explanatory diagram for illustrating an example of identifying the cause of quality deterioration according to this embodiment. The detection apparatus includes a reference value DB 100. The reference value DB 100 holds distribution information 101 for each combination of a host from which a user downloads data and the transferred byte count of data downloaded by the user. The distribution information 101 is a histogram in which the horizontal axis represents the download time and the vertical axis represents the download count. A reference value for the download time is set in each piece of the distribution information 101. The reference value employed is, for example, a median in the distribution information 101 in question.

For each Hypertext Transfer Protocol (HTTP) log, the detection apparatus identifies the distribution information 101 that has the same combination of a host and a transferred byte count (<host1, nbdt1>, <host1, nbdt2>, . . . <host2, nbdt3>) as the HTTP log to compare the reference value of the identified distribution information 101 with a download time in the HTTP log. The detection apparatus calculates a reference value ratio as the result of the comparison. Thereafter, the detection apparatus counts the count of HTTP logs downloaded by the user that overlap in time with the download time of the HTTP log for which the reference value ratio has been calculated. The result of the counting is referred to as parallel count. The detection apparatus multiplies the reference value ratio by the parallel count to calculate a Quality of Experience (QoE) value. The QoE value is an index value that indicates the quality of communication experienced by the user.

The detection apparatus compares the QoE value with a threshold T to detect quality deterioration, and identifies a log and traffic that correspond to the detected quality deterioration. The identified log and traffic are retrieved from the RRD to be saved in the accumulation DB. The log and traffic saved in the accumulation DB can be used for the analysis of the cause of a failure. By thus limiting data of a log and traffic that is stored in the accumulation DB to one necessary for the analysis of communication quality deterioration, the storage capacity of the accumulation DB can be reduced.

<Network Configuration Example>

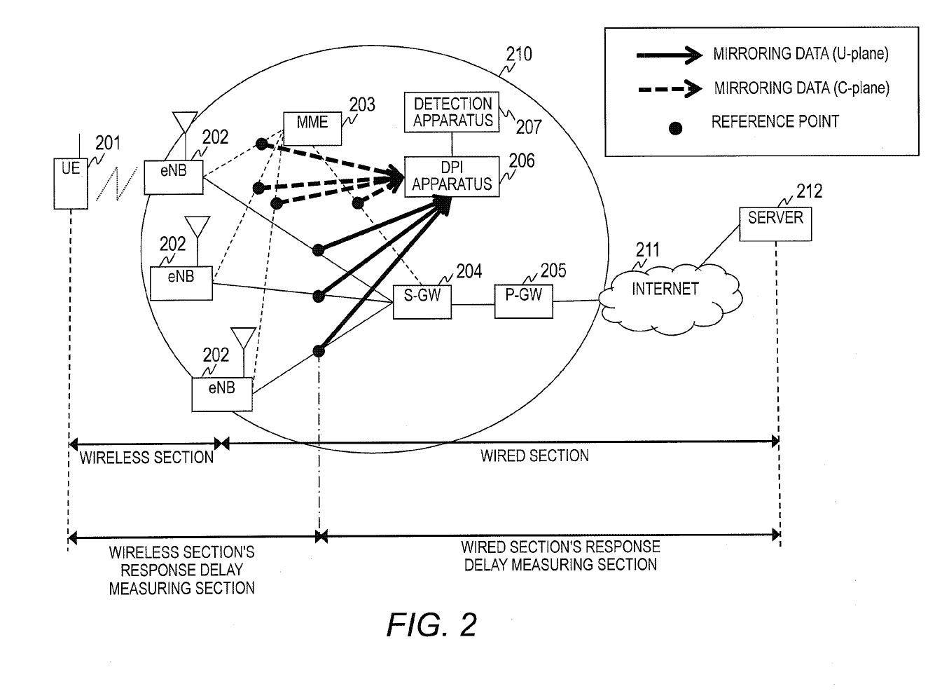

FIG. 2 is an explanatory diagram for illustrating a configuration example of a network that includes the detection apparatus according to this embodiment. While FIG. 2 illustrates as an example a Long Term Evolution (LTE) network 210, the LTE network 210 may be replaced by a 3G network or a next-generation network that follows 3G networks. In FIG. 2, a terminal 201 is communication equipment used by a user, and downloads data via the LTE network 210 and an Internet network 211 from a server 212, which is a host. The LTE network 210 includes base stations (eNBs) 202, a mobility management entity (MME) 203, a serving gateway (S-GW) 204, a packet data network gateway (P-GW) 205, a Deep Packet Inspection (DPI) apparatus 206, and the detection apparatus, which is denoted by 207.

The base stations 202 hold wireless communication to and from the terminal 201. The base stations 202 transmit to the S-GW 204 U-plane packets, which constitute user traffic, and transmit to the MME 203 C-plane packets, which constitute control traffic. The MME 203 is an access gateway of C-plane packets which handles network control. The S-GW 204 is a gateway that handles U-plane packets. The P-GW 205 is a gateway for coupling to the Internet.

The DPI apparatus 206 uses DPI, which is one of technologies of inspecting packets in a network, to inspect communication between the terminal 201 and the server 212. Specifically, the DPI apparatus 206 refers to the contents of U-plane packets and C-plane packets at reference points illustrated in FIG. 2, and generates logs thereof. The DPI apparatus 206 transmits the generated logs to the detection apparatus 207. The DPI apparatus 206 also transmits to the detection apparatus 207 a U-plane packet data group and a C-plane packet data group which are created by mirroring at the reference points (hereinafter also collectively referred to as “packet data groups”). The detection apparatus 207 obtains the logs and the packet data groups from the DPI apparatus 206 and, in the manner illustrated in FIG. 1, detects deterioration in communication quality between the terminal 201 and the server 212 and saves portions of the logs and the packet data groups that correspond to the deterioration.

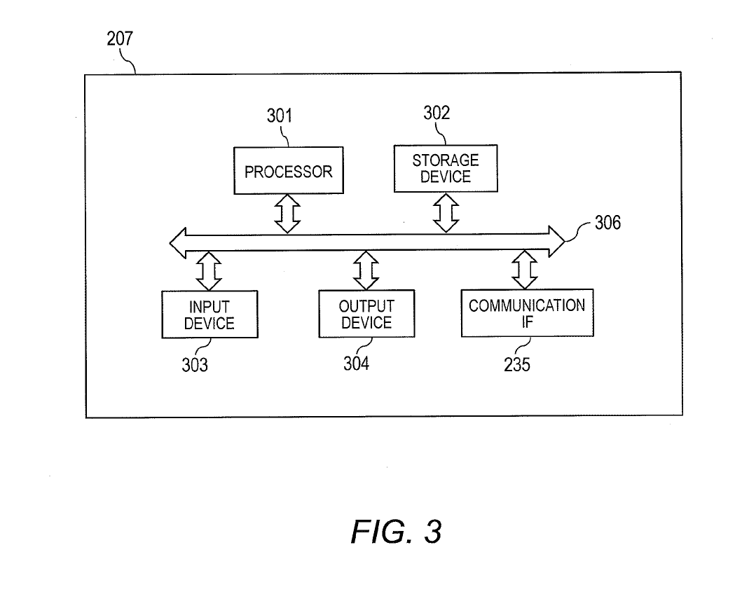

FIG. 3 is a block diagram illustrating a hardware configuration example of the detection apparatus 207. The detection apparatus 207 includes a processor 301, a storage device 302, an input device 303, an output device 304, and a communication interface (communication IF) 305. The processor 301, the storage device 302, the input device 303, the output device 304, and the communication IF 305 are connected to one another by a bus. The processor 301 controls the detection apparatus 207. The storage device 302 serves as a work area of the processor 301. The storage device 302 is a recording medium which stores various programs and data. The storage device 302 can be, for example, a read-only memory (ROM), a random access memory (RAM), a hard disk drive (HDD), or a flash memory. The input device 303 inputs data. The input device 303 can be, for example, a keyboard, a mouse, a touch panel, a ten-key pad, or a scanner. The output device 304 outputs data. The output device 304 can be, for example, a display or a printer. The communication IF 305 couples to a network to transmit and receive data.

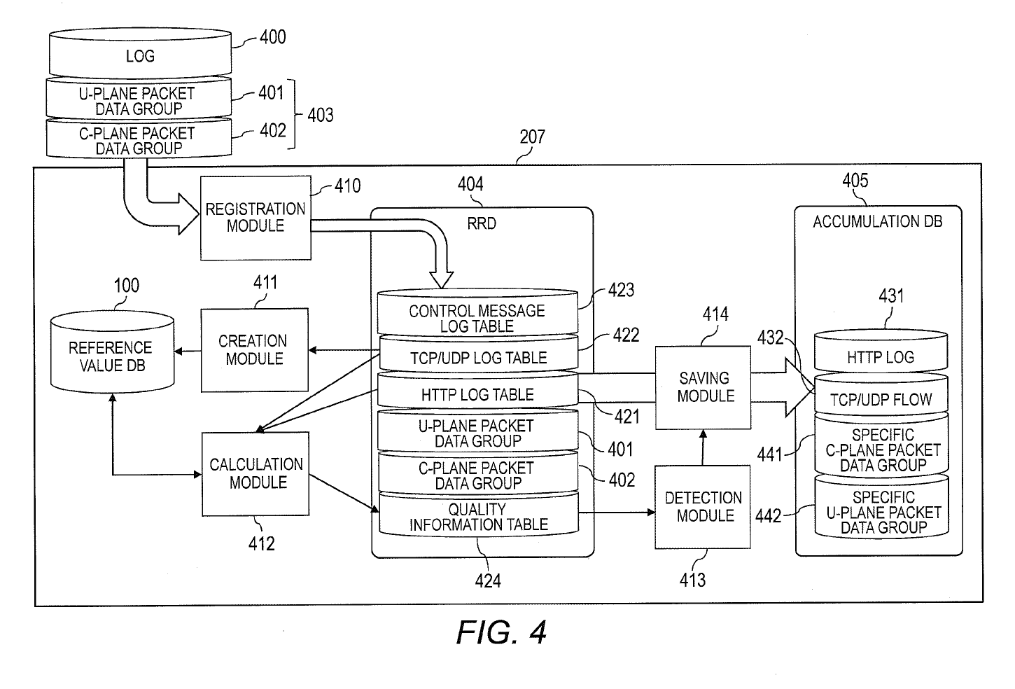

FIG. 4 is a block diagram illustrating a functional configuration example of the detection apparatus 207. The detection apparatus 207 includes an RRD 404, an accumulation DB 405, the reference value DB 100, a registration module 410, a creation module 411, a calculation module 412, a detection module 413, and a saving module 414. The RRD 404, the accumulation DB 405, and the reference value DB 100 implement their functions specifically by the storage device of FIG. 3, for example. The registration module 410, the creation module 411, the calculation module 412, the detection module 413, and the saving module 414 implement their functions specifically by executing with the processor 301 programs that are stored in the storage device 302 of FIG. 3, for example.

The RRD 404 is, as described above, a database which accumulates a given amount of data and erases the accumulated data starting from the oldest data when the given amount is exceeded. The RRD 404 starts data deletion with the oldest reception data when, for example, the total amount of data registered in the RRD 404 reaches a threshold (e.g., 80% of the entire storage area of the RRD 404). The accumulation DB 405 is a database that is put downstream of the RRD 404. The reference value DB 100 is a database that stores, as illustrated in FIG. 1, the distribution information 101 for each combination of a host and a transferred byte count (downlink). The distribution information 101 may be stored in advance, or may be created by the detection apparatus 207. In the case where the distribution information 101 is created by the detection apparatus 207, the creation module 411 creates the distribution information 101.

The registration module 410 receives from the DPI apparatus 206 a log 400 of a packet data group 403 (a packet data group 401 and a packet data group 402) as well as the packet data group 403. The log 400 includes a Transmission Control Protocol (TCP)/User Datagram Protocol (UDP) log and an HTTP log, which are logs about U-plane packets, and a control message log, which is a log about C-plane packets. The log 400 and the packet data group 403 are received from the DPI apparatus 206 at regular time intervals, for example.

When the received log 400 is an HTTP log, the registration module 410 stores the HTTP log in an HTTP log table 421 of the RRD 404. When the received log 400 is a TCP log or a UDP log, the registration module 410 stores the TCP log or the UDP log in a TCP/UDP log table 422 of the RRD 404. When the received log 400 is a control message log, the registration module 410 stores the control message log in a control message log table 423. When receiving the packet data group 403, the registration module 410 stores the packet data group 403 in the RRD 404.

The tables 421 to 423 are described below. While various types of information in the present invention are in a table format in the following description, the information does not always need to have the data structure of a table, and may have a list structure, a DB structure, a queue structure, or other data structures. Therefore, a table, a list, a DB, a queue, or the like may simply be referred to as “information” in order to indicate that the information does not depend on its data structure. Terms “identification information”, “identifier”, “name”, and “ID” may be used in descriptions on the specifics of the various types of information, and one term can be read as another in the descriptions. The same applies to other tables than the tables 421 to 423.

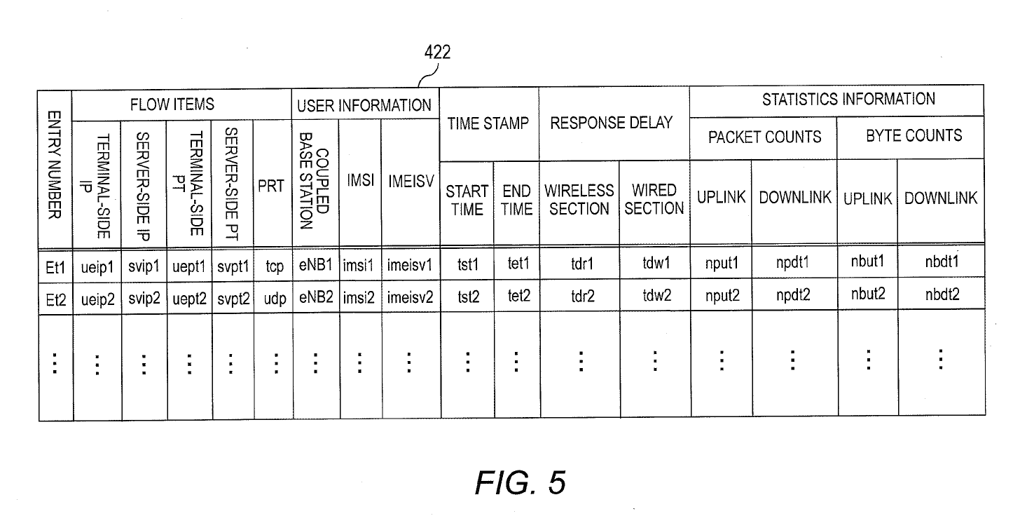

FIG. 5 is an explanatory diagram for illustrating an example of what is stored in the TCP/UDP log table 422. The TCP/UDP log table 422 is a table that stores a TCP/UDP log for each TCP flow or UDP flow which is a flow of U-plane packets. Each TCP/UDP log of a flow includes an entry number, flow items, user information, a time stamp, a response delay, and statistics information.

The entry number is identification information for uniquely identifying the TCP flow or UDP flow in question. The flow items include a terminal-side IP, a server-side IP, a terminal-side port number, a server-side port number, and a protocol. The terminal-side IP is the IP address of the user's terminal 201 in the flow. The server-side IP is the IP address of the server 212 in the flow. The terminal-side port number is the port number of the user's terminal 201 in the flow. The server-side port number is the port number of the server 212 in the flow. The protocol indicates the protocol type (TCP or UDP) of the flow.

The user information includes a coupled base station, an International Mobile Subscriber Identity (IMSI), and an International Mobile Equipment Identity Software Version (IMEISV). The coupled base station is information for identifying a coupled base station that holds wireless communication to and from the user's terminal 201 in a session between the user's terminal 201 and the server 212 in the TCP/UDP flow. The IMSI is an international subscriber identification number issued to the user who is a mobile phone subscriber. The IMEISV is identification information assigned to the user's terminal 201.

The time stamp includes a start time and an end time. The start time indicates a time at which a session has started in the DPI apparatus 206 (for example, the time when a request to start the session has been made) in the TCP/UDP flow. The end time indicates a time at which the session has ended (for example, the time of the last response) in the DPI apparatus 206 in the TCP/UDP flow.

The response delay is information for identifying a delay in response in the TCP/UDP flow. The response delay includes a response delay in a wireless section and a response delay in a wired section. The response delay in a wireless section is the length of a response delay in a wireless section's response delay measuring section, which is illustrated in FIG. 2. The response delay in a wired section is the length of a response delay in a wired section's response delay measuring section, which is illustrated in FIG. 2.

The statistics information includes packet counts (uplink and downlink) and byte counts (uplink and downlink). The packet count (uplink) is the count of packets that are transmitted from the user's terminal 201 to the server 212 in the TCP/UDP flow. The packet count (downlink) is the count of packets that are transmitted from the server 212 to the user's terminal 201 in the flow. The byte count (uplink) is the byte count of packets that are transmitted from the user's terminal 201 to the server 212 in the flow. The byte count (downlink) is the byte count of packets that are transmitted from the server 212 to the user's terminal 201 in the flow.

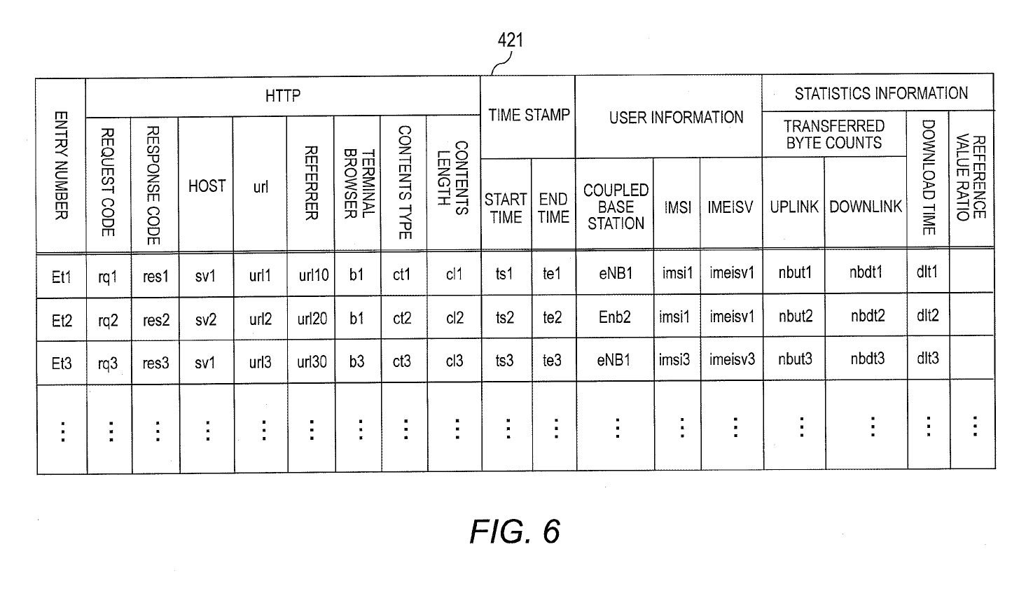

FIG. 6 is an explanatory diagram for illustrating an example of what is stored in the HTTP log table 421. The HTTP log table 421 is a table that stores an HTTP log for each HTTP flow which is a flow of U-plane packets. Each HTTP log includes an entry number, a request code, a response code, a host, a URL, a referrer, a terminal browser, a contents type, a contents length, a time stamp, user information, and statistics information.

The entry number is identification information for uniquely identifying the HTTP flow in question. The request code is a code identifying the specifics of an HTTP request in the HTTP flow. The response code is a code identifying the specifics of an HTTP response in the HTTP flow.

The host is information for identifying the server 212 that is the access destination of the user's terminal 201 in the HTTP flow. The URL is a URL that indicates the access destination of the server 212 identified by the host of the entry. The referrer is a URL that indicates a link source of the access destination of the server 212 identified by the host of the entry. The terminal browser is information for identifying a browser (for example, a browser name) that is used on the user's terminal 201.

The time stamp includes a start time and an end time. The start time indicates a time at which a session has started in the DPI apparatus 206 (for example, the time when a request to start the session has been made) in the HTTP flow. The end time indicates a time at which the session has ended (for example, the time of the last response) in the DPI apparatus 206 in the HTTP flow. The user information of the HTTP log table 421 is the same as the user information of the TCP/UDP log table 422, and a description thereof is omitted.

The statistics information includes transferred byte counts (uplink and downlink), a download time, and a reference value ratio. The transferred byte count (uplink) is the byte count of data transferred from the user's terminal 201 to the server 212, which is the host to the terminal, in the HTTP flow. The transferred byte count (downlink) is the byte count of data transferred to the user's terminal 201 from the server 212, which is the host to the terminal, in the HTTP flow.

The download time is a time required to transfer an amount of data that is indicated by the transferred byte count (downlink), and is calculated by subtracting the start time of the time stamp from the end time of the time stamp. The reference value ratio is, as described above with reference to FIG. 1, the ratio of the reference value of distribution information and a download time in the HTTP log. In registration processing executed by the registration module 410, pieces of information that are constituents of an entry of the HTTP log table 421 are stored in the HTTP log table 421, except the reference value ratio.

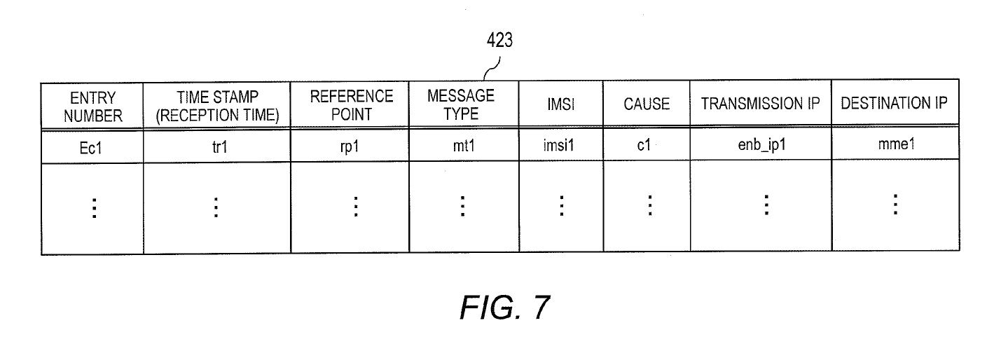

FIG. 7 is an explanatory diagram for illustrating an example of what is stored in the control message log table 423. The control message log table 423 is a table that records, for each control message which is a C-plane packet, the contents of the control message. Each control message log of a control message includes an entry number, a time stamp, a reference point, a message type, an IMSI, a cause, a transmission IP, and a destination IP.

The entry number is information for uniquely identifying the control message in question. The time stamp is a time at which the control message has been received by the DPI apparatus 206. The reference point is information that indicates a logical point where the control message has been mirrored as illustrated in FIG. 2. Specifically, the reference point is identified by a combination of a transmission IP address, a destination IP address, and a host protocol that are contained in the received IP packet. The message type is information that indicates the type (a coupling request or the like) of the control message. The IMSI is, as described above, an international subscriber identification number issued to the user who is a mobile phone subscriber. The cause is information for identifying the cause of a communication failure or communication quality deterioration. A communication quality deterioration event of the terminal 201/base station 202 or a failure event of the MME 203 is uniquely identified by the combination of the message type and the cause.

For example, when the message type is “UE CONTEXT RELEASE REQUEST message and the cause is “radio-connection-with-ue-lost”, communication quality deterioration of the terminal 201 is identified. When the message type is “SERVICE REJECT” and the cause is “congestion”, a failure of the MME 203 is identified. The transmission IP is the IP address of an apparatus that is the sender of the control message. The reception IP is the IP address of an apparatus that is the receiver of the control message. The sender apparatus/receiver apparatus is one of the base stations 202, the MME 203, or the S-GW 204.

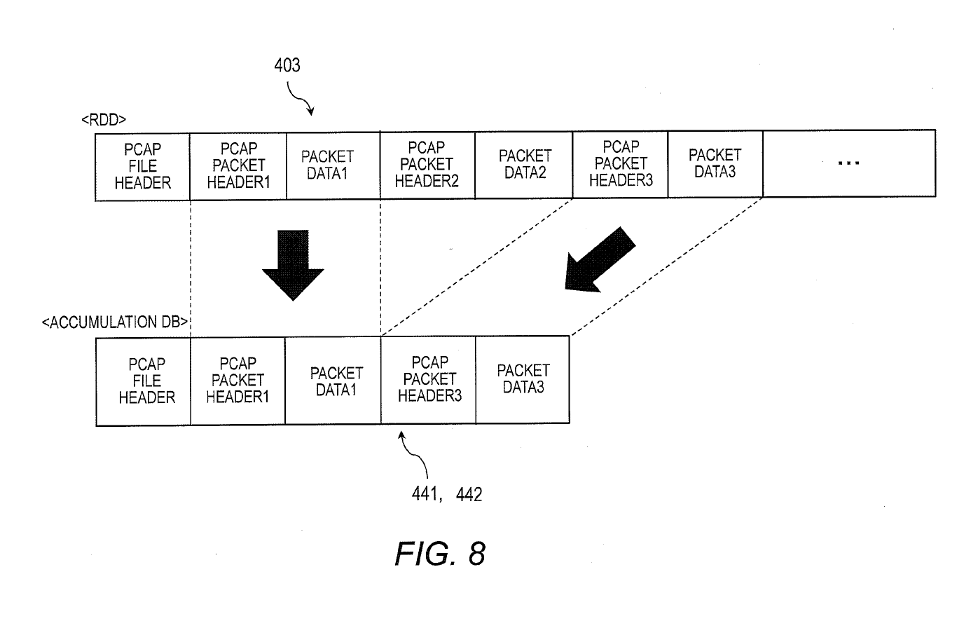

FIG. 8 is an explanatory diagram for illustrating an example of the packet data group 403. The packet data group 403 is transmitted from the DPI apparatus 206 in a file format, for example, the packet capture (Pcap) file. The data structure of the packet data group 403 is described here by taking the Pcap file as an example. However, the format of the packet data group 403 is not limited to the Pcap file. The packet data group 403 is stored in the RRD 404, and then specific packet data groups 441 and 442 which correspond to quality deterioration are stored in the accumulation DB 405.

The packet data group 403 includes one Pcap file header and at least one combination of a Pcap packet header and packet data (packet). The Pcap file header of a Pcap file is the overall header of the Pcap file. Regardless of whether packets in the packet data group 403 are U-plane packets or C-plane packets, the Pcap file header has information identifying packets that are contained in the Pcap file. For example, the Pcap file header uses a time at which the head packet has been received by the DPI apparatus 206 and a given length of time counted from the time of reception to indicate that packets within the given length of time from the time of reception are contained.

The Pcap packet header of a packet stores a time at which the packet has been received by the DPI apparatus 206, the packet length of the packet, and the capture length of the packet. The capture length is a length of the packet that has been captured when the packet is contained in the Pcap file. For example, in the case where the capture length is defined as top sixty-four bytes, sixty-four bytes of data from the head are held as packet data in the Pcap file. In other words, the packet length is the data length of the packet itself, whereas the capture length is the data length of packet data captured from the packet. The packet data is data that is captured from the packet so as to have the capture length.

In the case of a C-plane packet, the Pcap packet header further stores an IMSI list. The DPI apparatus 206 stores in the IMSI list IMSIs relevant to a control message which is a C-plane packet. An IMSI relevant to a control message is, for example, the IMSI of the terminal 201 that is the sender or destination of the control message. In the case where one C-plane packet contains one control message, for example, an IMSI relevant to the control message is stored in the IMSI list. In the case where one C-plane packet contains a plurality of control messages, IMSIs relevant to the respective control messages are stored in the IMSI list.

Referring back to FIG. 4, the creation module 411 refers to the HTTP log table 421 to create the distribution information 101 and the reference value of the distribution information 101, and stores the distribution information 101 and the reference value in the reference value DB 100. As illustrated in FIG. 1, the distribution information 101 is created for each combination of a host from which the user downloads data and a transferred byte count of data downloaded by the user.

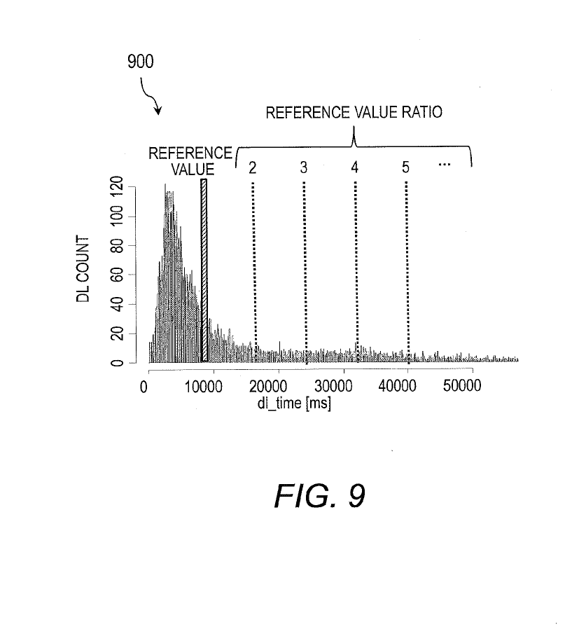

FIG. 9 is an explanatory diagram for illustrating an example of the distribution information. The distribution information, which is denoted here by 900, is created for each combination of a transferred byte count of downloaded data and a host. The distribution information 900 is a histogram in which the horizontal axis represents the download time and the vertical axis represents the download count. For example, the count of entries in the HTTP log table 421 which represent a combination of a transferred byte count of downloaded data and a host is counted as the download count on the vertical axis, and download times of the respective entries are plotted on the horizontal axis. The reference value of the distribution information 900 for a combination of a transferred byte count of downloaded data and a host is an index value that provides a basis for determining the quality of communication between the user's terminal 201 and the server 212 that is the host, for example, a median of the distribution information 900. The reference value may instead be an average value or a modal value.

Referring back to FIG. 4, the calculation module 412 uses the reference value DB 100, the HTTP log table 421, and the TCP/UDP log table 422 to calculate statistical values, to thereby create a quality information table 424. The calculation module 412 stores, and updates with the passage of time, the statistical values in the quality information table 424 for the user's terminal 201, the base stations 202, and the MME 203, which are monitoring subjects. The following is a description on the quality information table 424.

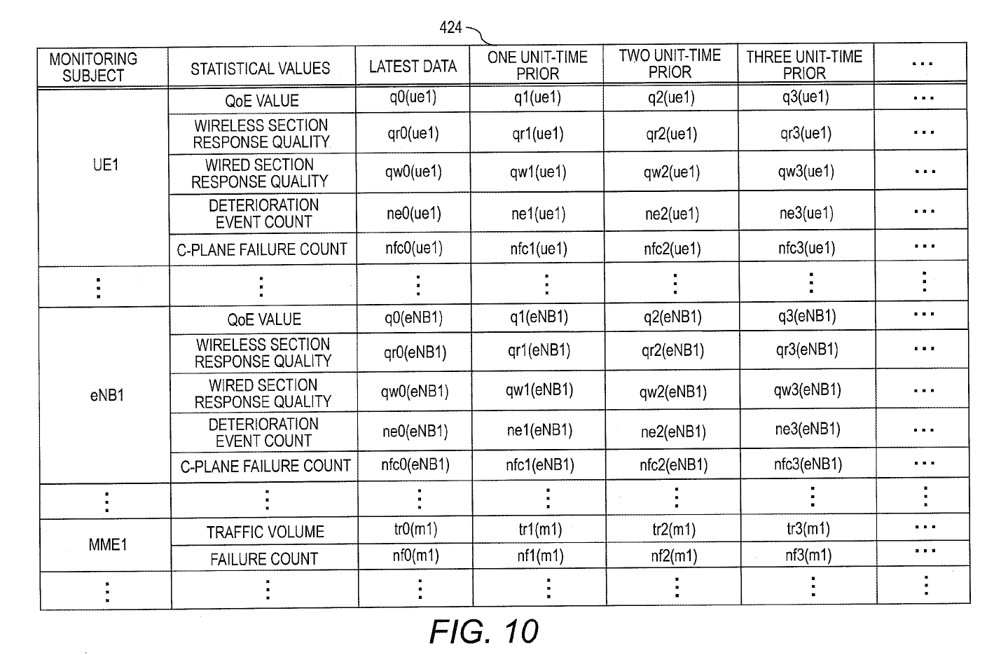

FIG. 10 is an explanatory diagram for illustrating an example of what is stored in the quality information table 424. The quality information table 424 is a table that stores the statistical values over time for each monitoring subject. Monitoring subjects are communication apparatus monitored for communication quality (the terminal 201, the base stations 202, and the MME 203). The terminal 201 is identified by an IMSI and an IMEISV that are registered as the user information in the HTTP log table 421 or the TCP/UDP log table 422. The base stations 202 are each identified by a coupled base station that is registered as the user information in the HTTP log table 421 or the TCP/UDP log table 422. The MME 203 is identified by a transmission IP address or a destination IP address that is registered in the control message log.

The statistical values are stored every unit time to be updated with the passage of time. One unit time is a unit time that can be set by an administrator, such as a minute, sixty minutes, three hours, twelve hours, or a day. The unit time can be set arbitrarily by the user. The following is a description on the statistical values of the terminal 201.

The statistical values of the terminal 201 include a QoE value, wireless section response quality, wired section response quality, a deterioration event count, and a C-plane failure count. The QoE value is an index value that indicates the quality of communication experienced by the user. The calculation module 412 calculates the QoE value. To give a concrete example, the calculation module 412 identifies entries of the HTTP log table 421 that hold as the user information an IMSI and IMEISV related to the terminal 201 that is the monitoring subject. For each identified entry, the calculation module 412 identifies a combination of a host and a transferred byte count (downlink).

For each identified combination, the calculation module 412 obtains the distribution information 900 from the reference value DB 100, and compares a download time of the entry for which the combination has been identified with the reference value of the obtained distribution information 900 to calculate the reference value ratio. The reference value ratio is calculated as, for example, (the reference value of the obtained distribution information 900)/(the download time of the entry for which the combination has been identified). Accordingly, communication quality is higher when the reference value ratio is larger.

The calculation module 412 then counts the count of HTTP logs downloaded by the user terminal 201 that overlap in time with the download time of the HTTP log for which the reference value ratio has been calculated. The result of the counting is referred to as parallel count. The calculation module 412 multiplies the reference value ratio by the parallel count to calculate the QoE value. The QoE value is calculated for each entry of the HTTP log table 421, and the calculation module 412 therefore obtains a representative QoE value from one or more QoE values calculated for one or more entries about the same user. The representative QoE value can be, for example, an average value, maximum value, minimum value, median, or modal value of the one or more QoE values. Which of those values is to be employed can be set in advance. The representative QoE value serves as the QoE value of the terminal 201 in question.

The wireless section response quality is an evaluation value that indicates the response quality of the wireless section illustrated in FIG. 2. When the throughput of the terminal 201 is large, the amount of data is accordingly large, which impairs the response quality of the wireless section, and the response quality also drops due to downlink data that is transmitted by the terminal 201 itself. However, the detection apparatus 207 determines the wireless section response quality as good when the terminal throughput is equal to or higher than a threshold set in advance, and determines the wireless section response quality as poor when the terminal throughput is less than the threshold. The wireless section response quality is calculated by, for example, the following Expression (1):

$$Wireless section response quality = 0 ( if terminal throughput \geq threshold ) = wireless section response delay ( if terminal throughput < threshold ) \qquad ( 1 )$$

The terminal throughput is obtained by dividing a byte count of the statistics information by a flow period in an entry of the TCP/UDP log table 422 that holds an IMSI and IMEISV related to the terminal 201 that is the monitoring subject. The byte count can be the uplink byte count or the downlink byte count. The byte count can also be the sum or an average value of the uplink byte count and the downlink byte count. The flow period is a period obtained by subtracting a start time of the time stamp in the entry in question from the end time of the time stamp. When the TCP/UDP log table 422 has a plurality of entries where an IMSI and IMEISV related to the terminal 201 that is the monitoring subject are registered, the sum or average of throughput values in the plurality of entries of the terminal 201 may be used as the throughput of the terminal 201. The wireless section response delay is obtained from the wireless section response delay of the TCP/UDP log table 422. A larger value of the wireless section response quality indicates a poorer quality.

The wired section response quality is an evaluation value that indicates the response quality of the wired section illustrated in FIG. 2. A wired section response delay is obtained from the wired section response delay of the TCP/UDP log table 422.

The deterioration event count is a count value obtained by counting deterioration events. A deterioration event is a control message (C-plane packet) that recognizes deterioration in the communication quality of the terminal 201, and is identified by a combination of the type of the control message about the communication quality deterioration and the cause of the deterioration. The combination is identified by the message type and the cause in a control message log. For example, a control message that is a “UE CONTEXT RELEASE REQUEST message” and that has “radio-connection-with-ue-lost” as the cause signifies a deterioration event. The deterioration event count may also be a count value counted separately for each combination of a control message that identifies a deterioration event and the cause of the control message, or may be the sum of the count values of all combinations.

The C-plane failure count is a count value obtained by counting control messages about session failures out of control messages related to the terminal 201 in question. For example, the C-plane failure count is a count value of messages that inform of the rejection of establishing a session, such as those whose message types are classified as “SERVICE REJECT messages”, “ATTACH REJECT messages”, and “TRACKING AREA UPDATE REJECT messages”. The C-plane failure count may be counted for each message type separately, or may be the sum of messages of all session failure message types.

The statistical values of the base stations 202 are described next. The QoE value of one base station 202 is a representative QoE value of a group of terminals to which the base station 202 is coupled. A terminal to which the base station 202 is coupled is identified by, for example, an IMSI and an IMEISV that are associated with the base station 202 in the user information of the HTTP log table 421. The representative value here is selected from an average value, maximum value, minimum value, median, and modal value of the QoE values of the terminal group. Which of the values is employed as the representative value can be set in advance.

The wireless section response quality of the base station 202 is also a representative value that represents the wireless section response qualities of the group of terminals to which the base station 202 is coupled. The representative value here is selected from an average value, maximum value, minimum value, median, and modal value of the wireless section response qualities of the terminal group. Which of the values is employed as the representative value can be set in advance.

The wired section response quality of the base station 202 is also a representative value that represents the wired section response qualities of the group of terminals to which the base station 202 is coupled. The representative value here is selected from an average value, maximum value, minimum value, median, and modal value of the wired section response qualities of the terminal group. Which of the values is employed as the representative value can be set in advance.

The deterioration event count of the base station 202 is also a representative value that represents the deterioration event counts of the group of terminals to which the base station 202 is coupled. The representative value here is selected from an average value, maximum value, minimum value, median, and modal value of the deterioration event counts of the terminal group. Which of the values is employed as the representative value can be set in advance. In the case where the deterioration event count is counted separately for each combination of a type of a control message about communication quality deterioration and the cause of the control message, the calculation module 412 calculates the representative value for each combination.

The C-plane failure count of the base station 202 is also a representative value that represents the C-plane failure counts of the group of terminals to which the base station 202 is coupled. The representative value here is selected from an average value, maximum value, minimum value, median, and modal value of the C-plane failure counts of the terminal group. Which of the values is employed as the representative value can be set in advance. In the case where the C-plane failure count is counted separately for each combination of a type of a control message about communication quality deterioration and the cause of the control message, the calculation module 412 calculates the representative value for each combination.

The statistical values of the MME 203 are a traffic volume and a failure count. The traffic volume is expressed as the count of entries in which the destination IP of the control message log indicates the MME 203 in question. Congestion at the MME 203 can be detected from the traffic volume.

The failure count is the count of control messages that recognize a failure in communication to and from the MME 203. A failure is identified by a combination of a type of a control message about a failure and the cause of the control message. The combination is identified by the message type and the cause in a control message log. For example, a control message that is a “UE CONTEXT RELEASE COMMAND message” and that has “load-balancing-tau-required” as the cause constitutes an entry that signifies a failure. The failure count may also be a count value counted separately for each combination of a control message that identifies a failure and the cause of the control message, or may be the sum of the count values of all combinations. Congestion at the MME 203 when there is a control message that identifies a failure can be detected from the failure count.

Referring back to FIG. 4, the detection module 413 refers to the quality information table 424 to detect quality deterioration. The detection module 413 detects quality deterioration for each monitoring subject in the quality information table 424. Quality deterioration of the terminal 201 is described first.

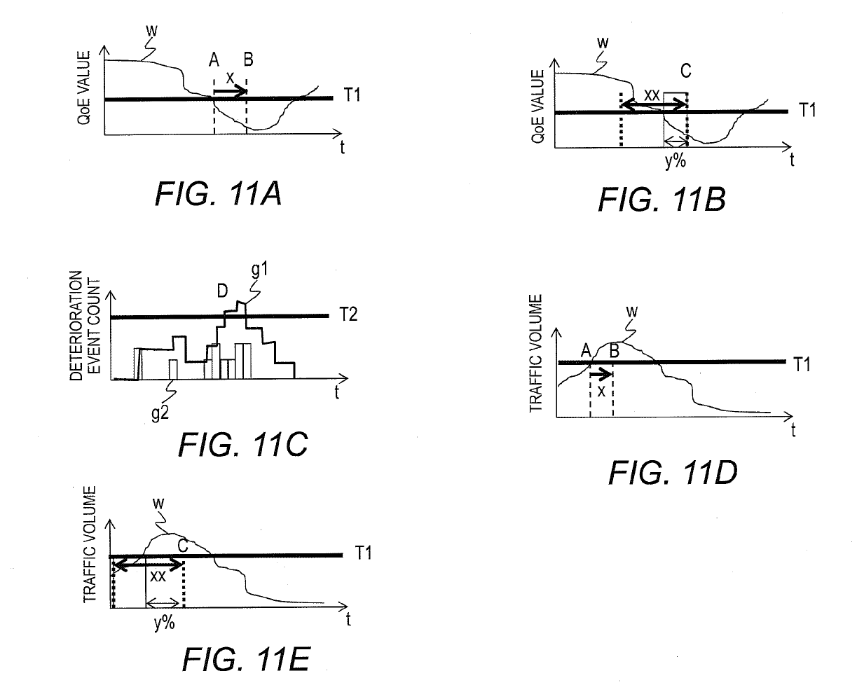

FIGS. 11A and 11B are graphs showing changes with time of the terminal 201 in QoE value. In FIGS. 11A and 11B, the horizontal axis represents the elapsed time and the vertical axis represents the QoE value of the terminal 201. A waveform w represents changes with time of the terminal 201 in QoE value. The waveform w is created by plotting QoE values of the terminal 201 at the respective unit times in the quality information table 424. A value T1 represents a threshold.

In FIG. 11A, the detection module 413 detects that the communication quality of the terminal 201 in question has deteriorated when, for example, the waveform w becomes equal to or less than the threshold T1 (a deterioration detection point A). Alternatively, the detection module 413 may detect that the communication quality of the terminal 201 in question has deteriorated when, for example, the waveform w becomes equal to or less than the threshold T1 (the deterioration detection point A) and continues to be equal to or less than the threshold T1 for a given length of time x since then (an interval between the deterioration detection point A and a deterioration detection point B).

As shown in FIG. 11B, the detection module 413 may also detect that the communication quality of the terminal 201 in question has deteriorated when, for example, a period in which the waveform w is equal to or less than the threshold T1 is y % (y is a value set in advance) or more of a period that begins a given length of time xx (xx is a value set in advance) prior to a deterioration detection point C (e.g., the current time).

FIG. 11C is a graph showing changes with time of the deterioration event count. The horizontal axis represents the elapsed time and the vertical axis represents the deterioration event count of the terminal 201. The deterioration count indicates, for example, the number of times connection is forcibly disconnected with a trouble in the wireless section as a “close reason” of a session. A bar graph g2 represents the deterioration event count and a sequential line graph g1 represents the interval sum of deterioration event counts. A value T2 represents a threshold. In the example of FIG. 11C, the detection module 413 detects that the communication quality of the terminal 201 has deteriorated when the sequential line graph g1 which represents the interval sum of deterioration event counts becomes equal to or more than the threshold T2 (a deterioration detection point D). The detection module 413 may detect that the communication quality of the terminal 201 has deteriorated simply when, instead of the interval sum, the deterioration event count represented by the bar graph g2 becomes equal to or more than the threshold T2.

In the case where the MME 203 is a monitoring subject, the vertical axis and bar graph of FIG. 11C are read as the failure count, and the detection module 413 may detect that the communication quality of the MME 203 has deteriorated when the sequential line graph representing the interval sum becomes equal to or more than the threshold T2. In the case where the base stations 202 are monitoring subjects, one of the detection methods shown in FIGS. 11A to 11C can be used.

FIGS. 11D and 11E show examples of detecting a burst in the MME 203, and are graphs that show changes with time in the volume of traffic to the MME 203. A waveform w here represents changes with time in the volume of traffic to the MME 203. The waveform w is created by plotting the volumes of traffic to the MME 203 at the respective unit times in the quality information table 424. A value T1 here represents a threshold.

In FIG. 11D, the detection module 413 detects that a burst has occurred in the MME 203 in question, namely, that a cause for communication quality deterioration has been generated, when, for example, the waveform w becomes equal to or more than the threshold T1 (a deterioration detection point A). Alternatively, the detection module 413 may detect that a burst has occurred in the MME 203 in question when, for example, the waveform w becomes equal to or more than the threshold T1 (the deterioration detection point A) and continues to be equal to or more than the threshold T1 for a given length of time x since then (an interval between the deterioration detection point A and a deterioration detection point B).

As shown in FIG. 11E, the detection module 413 may also detect that a burst has occurred in the MME 203 in question when, for example, a period in which the waveform w is equal to or more than the threshold T1 is y % (y is a value set in advance) or more of a period that begins a given length of time xx (xx is a value set in advance) prior to a deterioration detection point C (e.g., the current time).

When detecting communication quality deterioration, the detection module 413 generates control data and transmits the control data to the saving module 414.

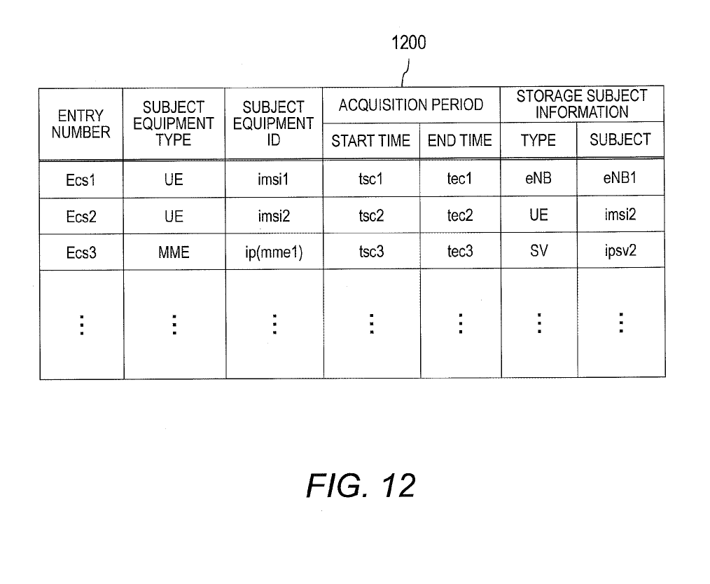

FIG. 12 is an explanatory diagram for illustrating the control data which is generated by the detection module 413. The control data, which is denoted by 1200, includes an entry number, a subject equipment type, a subject equipment ID, an acquisition period, and storage subject information, and each entry identifies one of the monitoring subjects of FIGS. 11A to 11E.

The entry number is identification information for uniquely identifying the control data 1200 in question. The subject equipment type indicates the type of equipment that is controlled by the control data 1200. A control subject of the control data 1200 is the terminal 201 (UE), the MME 203, or one of the base stations 202. The subject equipment ID is identification information for uniquely identifying the equipment of the subject equipment type. When the subject equipment type indicates the terminal 201, for example, the subject equipment ID is an IMSI (“imsi1” is given as an example). When the subject equipment type indicates the MME 203, the subject equipment ID is an IP address assigned to the MME 203 (“ip(mme1)” is given as an example).

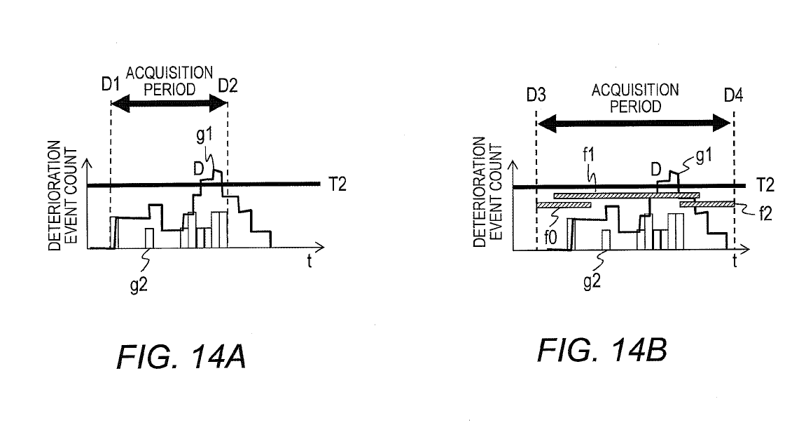

The acquisition period is information for identifying a time range of the log 400 and the packet data group 403 that are obtained from the RRD 404. The acquisition period includes a start time and an end time, and the log 400 and the packet data group 403 that are within the range between the start time and the end time are obtained. The acquisition period is determined by the detection module 413 with, for example, the deterioration detection points A to D of FIGS. 11A to 11E as reference. A concrete example of the acquisition period is described later with reference to FIGS. 14A and 1413.

The storage subject information is a filter for extracting specific types of logs (an HTTP log 431 and a TCP/UDP flow 432) and the specific packet data groups 441 and 442 from the log 400 and the packet data group 400 which are stored in the RDD 404. The storage subject information includes a type and a subject. The type indicates the type of a storage subject, and includes, for example, “terminal (UE)”, “base station (eNB)” and “apparatus which the terminal 201 holds communication to and from” (for example, “server”). The subject is information for identifying an individual piece of equipment that corresponds to the type. This identification information is an IMSI when the subject is the terminal 201, and a base station ID when the subject is one of the base stations 202.

A description is given on a method of setting the storage subject information. The case where the subject equipment type indicates the terminal 201 is described first. When the wireless section response quality which is one of the statistical values is equal to or more than a threshold (or when the wireless section response quality is continuously equal to or more than the threshold for a period that reaches back multiple-unit time from the time point of the latest data), it is determined that there is a problem with the communication quality of the base station 202 to which the terminal 201 is coupled. Then “base station (eNB)” is stored as the type and a base station ID that uniquely identifies this base station 202 (“eNB1”) is stored as the subject as shown in an entry Ecs1. Traffic (U-plane packets) passing through the base station (eNB1) to which the terminal (imsi1) is coupled can thus be extracted.

When the wireless section response quality of the statistical values is less than the threshold (or when the wireless section response quality is less than the threshold in any one of periods that reach back multiple-unit time from the time point of the latest data), it is determined that there is a problem with the communication quality of the terminal 201. Then “terminal (UE)” is stored as the type and an equipment ID that uniquely identifies the terminal 201 (“imsi2”) is stored as the subject as shown in an entry Ecs2. A log of traffic (U-plane packets) of the terminal (imsi2) can thus be extracted.

When the wired section response quality which is one of the statistical values is equal to or more than a threshold (or when the wired section response quality is continuously equal to or more than the threshold for a period that reaches back multiple-unit time from the time point of the latest data), it is determined that there is a problem with the communication quality of an apparatus which the terminal 201 holds communication to and from. Then “server (SV)” is stored as the type and an IP address that uniquely identifies the server is stored as the subject as shown in an entry Ecs3. A log of traffic (U-plane packets) of the server 212 which holds communication to and from the terminal 201 can thus be extracted. When the wired section response quality of the statistical values is less than the threshold (or when the wired section response quality is less than the threshold in any one of periods that reach back multiple-unit time from the time point of the latest data), the same values as in the case of the wireless section response quality are stored, and a description thereof is omitted here.

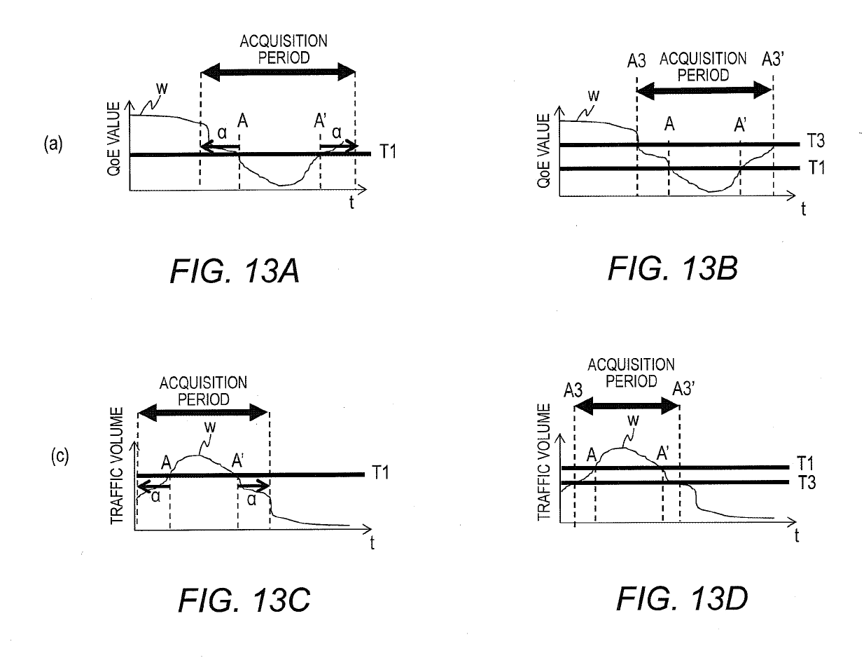

FIGS. 13A to 13D are explanatory diagram for illustrating examples of how the acquisition period of FIG. 12 is determined. FIG. 13A shows an example of determining the acquisition period in the case where deterioration is detected by the method of FIG. 11A. In FIG. 13A, a time point that precedes the deterioration detection point A by a given length of time α (α≧0) is set as the start time of the acquisition period, and a time point that is past a time point A′, where the waveform w becomes equal to or more than the threshold T1 again, by the length of time α is set as the end time of the acquisition period.

In FIG. 13B, a threshold T3 which is higher than the threshold T1 is set in advance, a point A3 where the waveform w becomes equal to or less than the threshold T3 prior to the deterioration detection point A is set as the start time of the acquisition period, and a time point A3′ at which the waveform w becomes equal to or more than the threshold T3 after the time point A′, where the waveform w becomes equal to or more than the threshold T1 again, is set as the end time of the acquisition period. In the case where deterioration is detected by the method of FIG. 11B, the acquisition period may be the interval xx of FIG. 11B, or may be a period that includes the length of time α preceding the interval xx and the length of time α that follows the interval xx.

FIG. 13C shows an example of determining the acquisition period in the case where deterioration is detected by the method of FIG. 11D. In FIG. 13C, a time point that precedes the deterioration detection point A by the given length of time α (α≧0) is set as the start time of the acquisition period, and a time point that is past the time point A′, where the waveform w becomes equal to or less than the threshold T1 again, by the length of time α is set as the end time of the acquisition period.

In FIG. 13D, a threshold T3 which is lower than the threshold T1 is set in advance, a point A3 where the waveform w becomes equal to or more than the threshold T3 prior to the deterioration detection point A is set as the start time of the acquisition period, and a time point A3′ at which the waveform w becomes equal to or less than the threshold T3 after the time point A′, where the waveform w becomes less than the threshold T1 again, is set as the end time of the acquisition period. In the case where deterioration is detected by the method of FIG. 11E, the acquisition period may be the interval xx of FIG. 11E, or may be a period that includes the length of time α preceding the interval xx and the length of time α that follows the interval xx.

FIGS. 14A and 14B show examples of determining the acquisition period in the case where deterioration is detected by the method of FIG. 11C. In FIG. 14A, a time point D1 where a deterioration event is detected first prior to the deterioration detection point D is set as the start time of the acquisition period, and a time point D2 where a deterioration event is detected last after the deterioration detection point D is set as the end time of the acquisition period.

In FIG. 14B, the acquisition period is determined with a flow f1, which includes the deterioration detection point D, as reference. Specifically, in the case where a flow f0 which precedes the flow f1 includes a deterioration event and partially overlaps in time with the flow f1, the flow f0 is included in the acquisition period. The same applies to flows (not shown) that precede the flow f0. In the case where a flow f2 which follows the flow f1 includes a deterioration event and partially overlaps in time with the flow f1, the flow f2 is included in the acquisition period. The same applies to flows (not shown) that follow the flow f2. The acquisition period in FIG. 14B which includes the flows f0 and f2 starts at the start time of the flow f0 and ends at the end time of the flow f2. This may be simplified by, for example, setting as the start time of the acquisition period the earlier of the start times of the flows f0 and f1, which are flowing at the time α deterioration event is detected first, and setting as the end time of the acquisition period the later of the end times of the flows f1 and f2, which are flowing at the time α deterioration event is detected last. The start time and end time of flows may be set as the start time and end time of the acquisition period also in FIG. 13A. Specifically, the earliest of the start times of flows that are flowing in a period between the quality deterioration time points A and A′ is set as the start time of the acquisition period, and the latest of the end times of the flows is set as the end time of the acquisition period.

<Example of Reference Value DB Creating Processing>

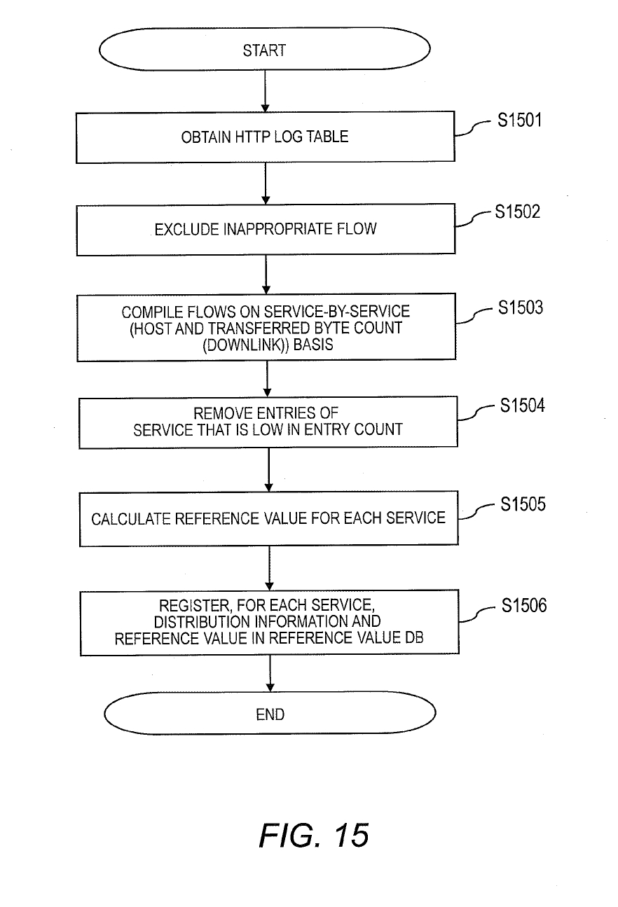

FIG. 15 is a flow chart illustrating an example of reference value DB creating processing, which is executed by the creation module 411. The creation module 411 obtains the HTTP log table 421 (Step S1501) and excludes an inappropriate flow (Step S1502). Because each entry in the HTTP log table 421 represents a flow, the creation module 411 determines for each entry of the HTTP log table 421 whether or not the entry is an inappropriate flow. For example, the creation module 411 excludes entries where the request code indicates a request code that does not involve downloading of data. The creation module 411 may also exclude entries where the transferred byte count is “0”.

The creation module 411 next compiles flows on a service-by-service basis (Step S1503). A service is identified by a combination of a host and a transferred byte count (downlink) in the HTTP log table 421. In other words, a service indicates how many bytes of data have been downloaded by the terminal 201 from a host. The creation module 411 compiles flows on a service-by-service basis by grouping entries by service.

Of the entry groups created through service-by-service compilation, the creation module 411 removes entry groups of services that are low in entry count (Step S1504). To give a concrete example, the creation module 411 may remove entry groups of services whose entry counts are equal to or less than a threshold, or may remove entry groups of services whose entry counts are the lowest to the x-th lowest.

The creation module 411 next calculates a reference value for each service (Step S1505). To give a concrete example, the creation module 411 creates the distribution information 900 for each service by plotting download times of the respective entries on the horizontal axis and the download counts on the vertical axis as illustrated in FIG. 1 or FIG. 9. The download time of an entry is identified by a download time that is registered as the statistics information in the entry. The download count is identified by the count of entries. The service-by-service distribution information 900 is created in this manner. The creation module 411 calculates a reference value for each piece of the distribution information 900. The reference value is calculated, as described above, as an average value, median, modal value, or the like of a histogram indicated by the distribution information 900.

The creation module 411 then registers for each service a combination of the distribution information 900 and a reference value in the reference value DB 100 (Step S1506). A reference for communication quality deterioration is thus obtained.

The processing illustrated in the flow chart of FIG. 15 may be executed prior to or at the start of operation by the detection apparatus 207, or may be executed at arbitrary timing during arbitrary operation. In the case where the processing is executed during the operation, all entries of the HTTP log table 421 may be used in the execution, or only entries where a reception time registered as the time stamp is most recent may be used.

<Example 1 of Processing of Creating the Quality Information Table 424>

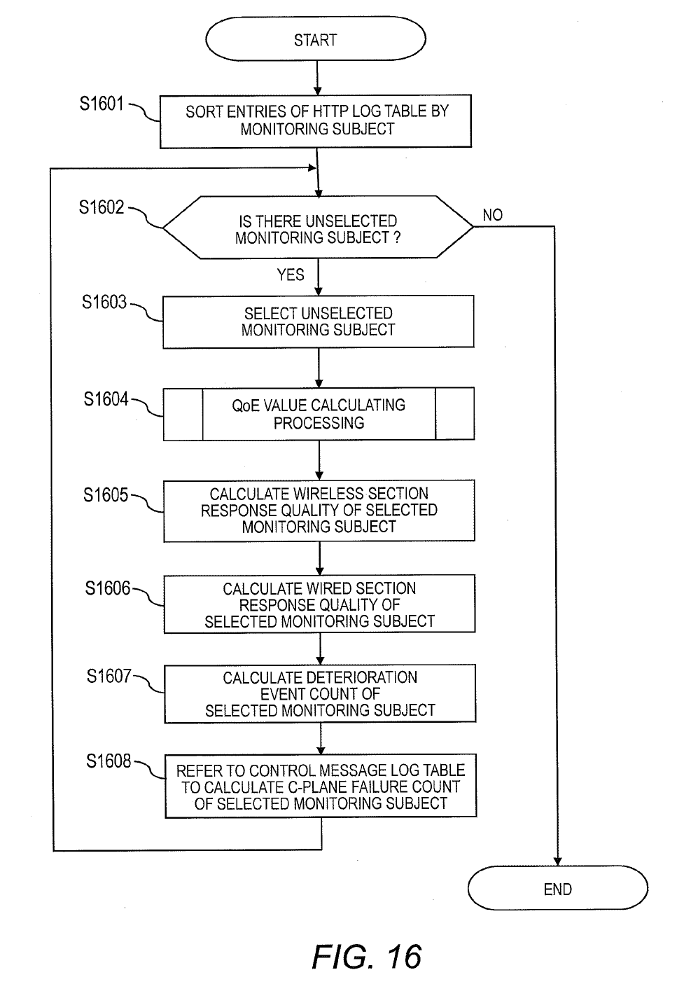

FIG. 16 is a flow chart illustrating Example 1 of processing of creating the quality information table 424 which is executed by the calculation module 412. The example of FIG. 16 illustrates the quality information table creating processing that is executed when the monitoring subject is the terminal 201 or one of the base stations 202. The calculation module 412 first sorts entries of the HTTP log table 421 by monitoring subject (Step S1601). The monitoring subject of an entry can be identified from the user information of the entry.

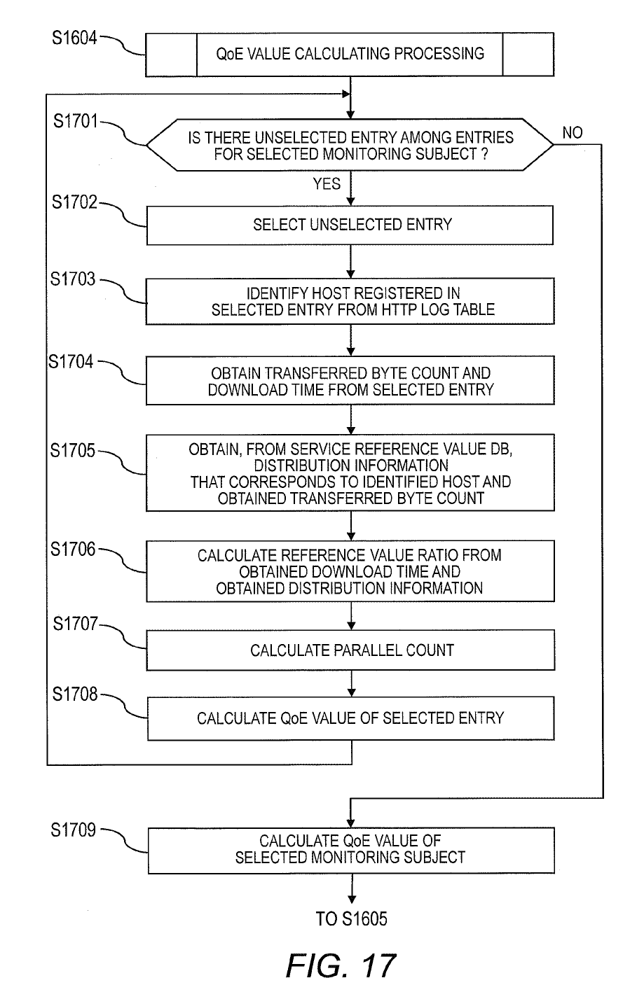

The calculation module 412 next determines whether or not monitoring subject groups created by the sorting include an unselected monitoring subject, which is a subject that has not been selected yet (Step S1602). When the groups include an unselected monitoring subject (Step S1602: Yes), the calculation module 412 selects the unselected monitoring subject (Step S1603). The calculation module 412 then executes QoE value calculating processing for the selected monitoring subject (Step S1604). The QoE value calculating processing (Step S1604) is described later with reference to FIG. 17. The QoE value of the selected monitoring subject which has been calculated by the QoE value calculating processing (Step S1604) is stored in the “latest data” column of the quality information table 424 in an entry for the selected monitoring subject. In the case where one of the base stations 202 is the monitoring subject, the QoE value of the selected monitoring subject is a representative QoE value of the terminals 201 to which the base station 202 is coupled.

The calculation module 412 next calculates the wireless section response quality of the selected monitoring subject (Step S1605). The wireless section response quality is calculated by Expression (1) described above. The wireless section response quality calculated is stored in the “latest data” column in the entry for the selected monitoring subject. In the case where one of the base stations 202 is a monitoring subject, the wireless section response quality of the selected monitoring subject is the representative value that represents the wireless section response qualities of the terminals 201 to which the base station 202 is coupled.

The calculation module 412 next calculates the wired section response quality (Step S1606). The wired section response quality is the wired section response delay that is registered for the selected monitoring subject in the TCP/UDP log table 422. The wired section response quality calculated is stored in the “latest data” column in the entry for the selected monitoring subject. In the case where one of the base stations 202 is the monitoring subject, the wired section response quality of the selected monitoring subject is a representative value that represents the wired section response qualities of the terminals 201 to which the base station 202 is coupled.

The calculation module 412 next calculates the deterioration event count of the selected monitoring subject (Step S1607). Deterioration events of the selected monitoring subject are identified by combinations of a message type of a control message about communication quality deterioration and the cause of the control message that are found in entries of the control message log table 423 that hold the IMSI of the selected monitoring subject. The calculation module 412 therefore counts the combinations. The calculation module 412 may count as the deterioration event count the entries for each combination separately, or may count the entries for each combination and then add the obtained count values together to use the sum as the deterioration event count. The calculated deterioration event count is stored in the “latest data” column in the entry for the selected monitoring subject. In the case where one of the base stations 202 is the monitoring subject, the deterioration event count of the selected monitoring subject is a representative value that represents the deterioration event counts of the terminals 201 to which the base station 202 is coupled.

The calculation module 412 next refers to the control message log table 423 to calculate the C-plane failure count of the selected monitoring subject (Step S1608). Specifically, the calculation module 412 calculates the C-plane failure count of the selected monitoring subject by, for example, counting control messages about a session failure out of control messages related to the terminal 201 that is the monitoring subject. The C-plane failure count may be counted for each message type separately, or may be the sum of messages of all session failure message types. The calculated C-plane failure count is stored in the “latest data” column in the entry for the selected monitoring subject. In the case where one of the base stations 202 is the monitoring subject, the C-plane failure count of the selected monitoring subject is a representative value that represents the C-plane failure counts of the terminals 201 to which the base station 202 is coupled. The calculation module 412 returns to Step S1602 after Step S1608.

In the case where no unselected monitoring subject is left (Step S1602: No), the calculation module 412 ends the series of processing steps. When the QoE value, wireless section response quality, wired section response quality, deterioration event count, and C-plane failure count of a selected monitoring subject are stored in the “latest data” column, values that have been stored in the “latest data” column shift to the “one unit-time prior” column. Similarly, values that have been stored in the “one unit-time prior” column shift to the “two unit-time prior” column. In this manner, values in the column for n unit-time prior data (n is an integer of 1 or more) shift to the column for (n+1) unit-time prior data.

<QoE Value Calculating Processing>

FIG. 17 is a flow chart illustrating an example of the QoE value calculating processing of FIG. 16 (Step S1604). The calculation module 412 first determines whether or not the entry group of the HTTP log table 421 to which the selected monitoring subject belongs includes an unselected entry, which is an entry that has not been selected yet (Step S1701). In the case where the group includes an unselected entry (Step S1701: Yes), the calculation module 412 selects the unselected entry (Steps S1702). The calculation module 412 obtains a host that is registered in the selected entry (Step S1703). For example, the calculation module 412 obtains “sv1” as the host when the selected entry is an entry Eh1 of FIG. 6.

The calculation module 412 next obtains the transferred byte count (downlink) and download time of the selected entry (Step S1704). For example, the calculation module 412 obtains “nbdt1” as the transferred byte count (downlink) and “dlt1” as the download time when the selected entry is the entry Eh1 of FIG. 6.

The calculation module 412 then obtains from the reference value DB 100 the distribution information 900 that corresponds to the combination of the obtained host and the obtained transferred byte count (downlink) (Step S1705). For example, the calculation module 412 obtains from the reference value DB 100 the distribution information 900 that corresponds to the combination of the host “sv1” and the transferred byte count (downlink) “nbdt1” when the selected entry is the entry Eh1 of FIG. 6.

The calculation module 412 next calculates the reference value ratio from the obtained download time and the obtained distribution information 900 (Step S1706). For example, when the selected entry is the entry Eh1 of FIG. 6, the calculation module 412 divides the obtained download time “dlt1” by the reference value of the obtained distribution information 900 to calculate the reference value ratio, and stores the calculated reference value ratio in the statistics information of the entry Eh1.

The calculation module 412 then calculates the parallel count for the selected entry (Step S1707). Taking the entry Eh1 and entries Eh2 and Eh3 of FIG. 6 as an example, when the selected monitoring subject is the terminal 201 that is identified by “imsi1” and “imeisv1”, and the selected entry is Eh1, an entry that is used in the calculation of the parallel count is the entry Eh2, which holds “imsi1” and “imeisv1” as the user information.

The calculation module 412 compares a download interval identified by the time stamp of the entry Eh1 which has a start time ts1 and an end time te1 and a download interval identified by the time stamp of the entry Eh2 which has a start time ts2 and an end time te2. In the case where the two intervals at least partially overlap with each other, it means that the entries Eh1 and Eh2 overlap, and the parallel count is accordingly “2”. In the case where the entries Eh1 and Eh2 do not overlap, on the other hand, only Eh1 which is the selected entry is counted in and the parallel count is accordingly “1”.

The calculation module 412 then calculates the QoE value of the selected entry (Step S1708) and returns to Step S1701. The QoE value of the selected entry is calculated by, for example, the following Expression (2).

Selected entry's QoE value=selected entry's reference value ratio×selected entry's parallel count (2)

When it is found in Step S1701 that no unselected entry is left (Step S1701: No), the calculation module 412 calculates the QoE value of the selected monitoring subject (Step S1709). Specifically, the calculation module 412 calculates the QoE value of the selected monitoring subject by, for example, obtaining a representative QoE value from one or more QoE values that are extracted from entries about the same user.

The representative QoE value is, for example, an average value, maximum value, minimum value, median, or modal value of the one or more QoE values. Which of the values is to be employed can be set in advance. The representative QoE value serves as the QoE value of the terminal 201 in question. Thereafter, the calculation module 412 moves to Step S1605 of FIG. 16. The QoE value in the case where the selected monitoring subject is the terminal 201 or one of the base stations 202 can thus be calculated by the QoE value calculating processing (Step S1604) of FIG. 17.

<Example 2 of Processing of Creating the Quality Information Table 424>

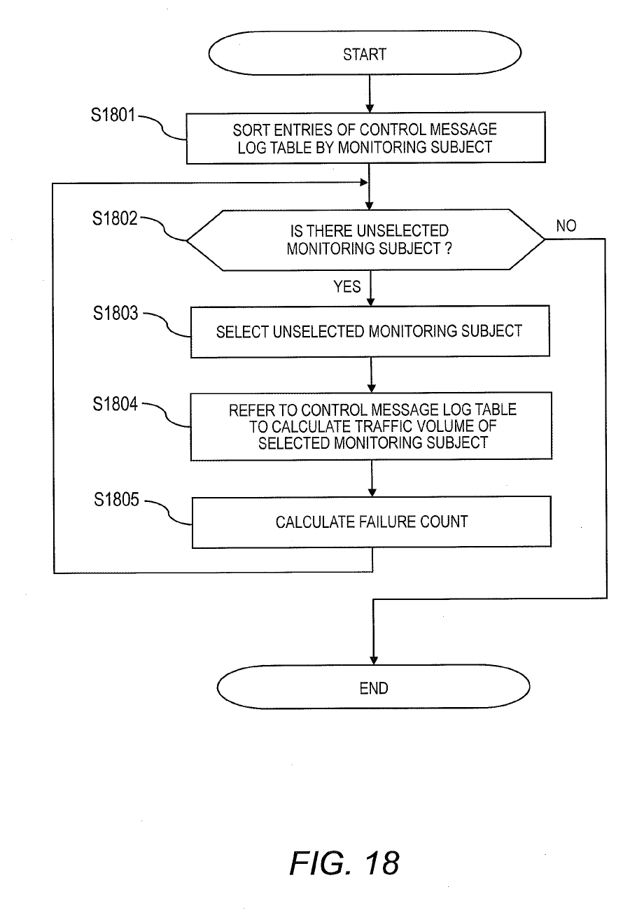

FIG. 18 is a flow chart illustrating Example 2 of processing of creating the quality information table 424 which is executed by the calculation module 412. The example of FIG. 18 illustrates the quality information table creating processing that is executed when the monitoring subject is the MME 203. The calculation module 412 first sorts entries of the control message log table 423 by MME 203, which is a monitoring subject (Step S1801). Specifically, the calculation module 412 sorts the entries of the control message log table 423 so that entries for any MME 203 are grouped together by, for example, referring to the IP address of the MME 203 that is stored as the destination IP in the control message log table 423.

The calculation module 412 next determines whether or not there is an unselected monitoring subject (Step S1802). In the case where an unselected monitoring subject is found (Step S1802: Yes), the calculation module 412 selects the unselected monitoring subject (Step S1803), and refers to the control message log table 423 to calculate the traffic volume of the MME 203 that is the selected monitoring subject (Step S1804). Specifically, the calculation module 412 calculates the traffic volume by, for example, counting entries where the destination IP indicates the MME 203 that is the selected monitoring subject. The calculated traffic volume of the selected monitoring subject is stored in the “latest data” column of the quality information table 424 in an entry for the selected monitoring subject.

The calculation module 412 then calculates the failure count for the selected monitoring subject (Step S1805) and returns to Step S1802. An entry that indicates a failure is identified by a combination of a message type and a cause that are registered in the control message log. For example, a control message that is a “UE CONTEXT RELEASE COMMAND message” and that has “load-balancing-tau-required” as the cause constitutes an entry that signifies a failure.

The calculation module 412 calculates the failure count of the selected monitoring subject by counting entries that indicate a failure with respect to the MME 203 that is the selected monitoring subject. The failure count may also be a count value counted separately for each combination of a control message that identifies a failure and the cause of the control message, or may be the sum of the count values of all combinations. The calculated failure count of the selected monitoring subject is stored in the “latest data” column in the entry for the selected monitoring subject.

When it is found in Step S1802 that no unselected monitoring subject is left (Step S1802: No), the calculation module 412 ends the series of processing steps. The timing of executing the processing of FIG. 16 and the timing of executing the processing of FIG. 18 may be the same or may differ from each other.

<Example of Deterioration Detecting Processing>

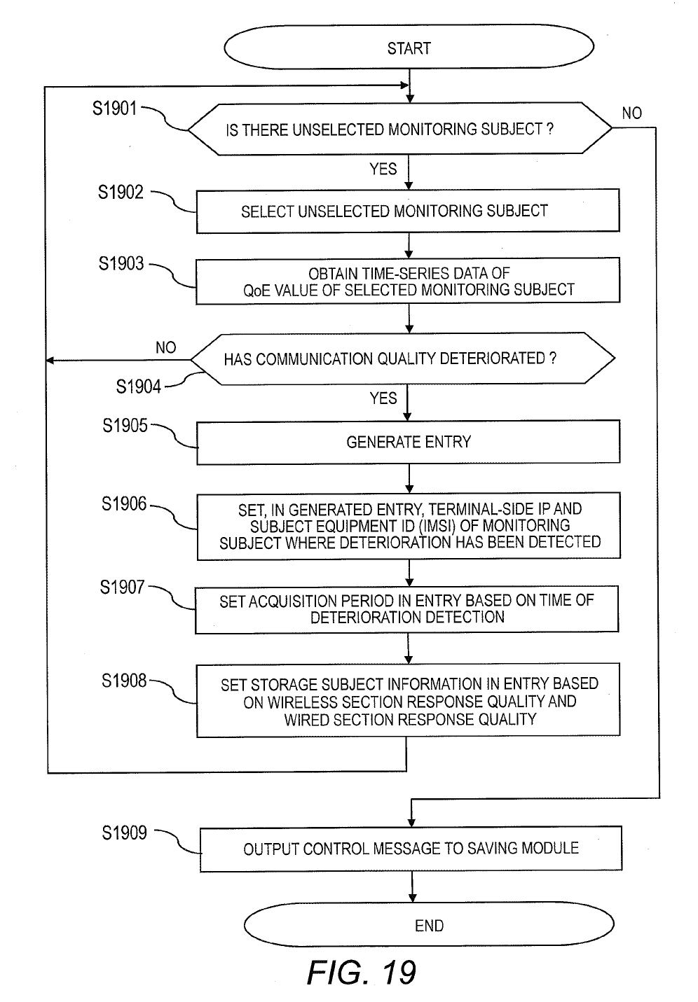

FIG. 19 is a flow chart illustrating an example of deterioration detecting processing, which is executed by the detection module 413. Here, a statistical value that is used for deterioration detection when the monitoring subject is the terminal 201 or one of the base stations 202 is the QoE value or the deterioration event count, and a statistical value that is used for deterioration detection when the monitoring subject is the MME 203 is the traffic volume or the failure count.

The detection module 413 first refers to the quality information table 424 to determine whether or not there is an unselected monitoring subject (Step S1901). When there is an unselected monitoring subject (Step S1901: Yes), the detection module 413 selects the unselected monitoring subject (Step S1902), and obtains time-series data of the statistical value of the selected monitoring subject from an entry for the selected monitoring subject in the quality information table 424 (Step S1903). Time-series data of a statistical value is a string of statistical values of a period that stretches over a given unit time from the time point of the latest data.

Based on the obtained time-series data of the QoE value, the detection module 413 determines whether or not the communication quality has deteriorated (Step S1904). This determination is made by one of the methods described above with reference to FIGS. 11A to 11E. In the case where the communication quality has not deteriorated (Step S1904: No), the detection module 413 returns to Step S1901. In the case where the communication quality has deteriorated (Step S1904: Yes), the detection module 413 generates an entry for the control data 1200 which is to be transmitted to the saving module 414 (Step S1905), and sets the terminal-side IP and subject equipment ID (IMSI) of the monitoring subject whose deterioration has been detected in the generated entry (Step S1906).

The detection module 413 also generates the acquisition period based on the time of deterioration detection, and sets the acquisition period in the generated entry (Step S1907). Specifically, the detection module 413 generates the acquisition period by, for example, one of the methods shown in FIGS. 13A to 13D and FIGS. 14A and 14B. The detection module 413 then generates the storage subject information based on the wireless section response quality and wired section response quality of the selected monitoring subject in the manner described above, sets the storage subject information in the generated entry (Step S1908), and returns to Step S1901.

Thereafter, in the case where no unselected monitoring subject is left (Step S1901: No), the detection module 413 outputs the control data 1200 to the saving module 414 (Step S1909), and ends the series of processing steps.

<Example of Storage Processing>

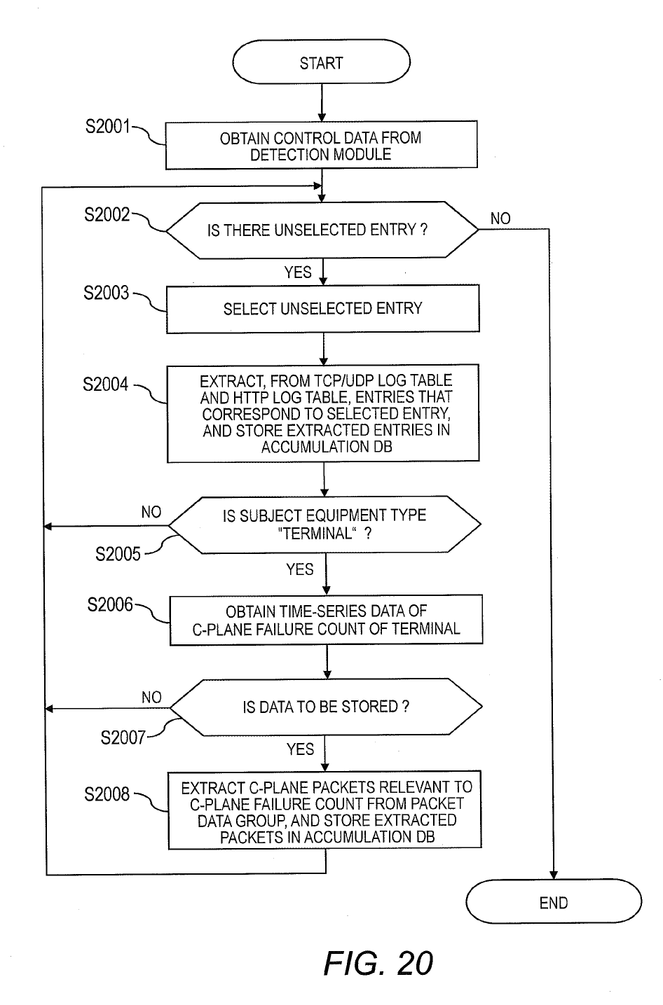

FIG. 20 is a flow chart illustrating an example of storage processing, which is executed by the saving module 414. The saving module 414 obtains the control data 1200 from the detection module 413 (Step S2001), and determines whether or not the control data 1200 includes an unselected entry (Step S2002). In the case where the control data 1200 includes an unselected entry (Step S2002: Yes), the saving module 414 selects the unselected entry (Step S2003). The saving module 414 then obtains entries that correspond to the selected entry from the TCP/UDP log table 422 and the HTTP log table 421, and stores the obtained entries in the accumulation DB 405 (Step S2004).

Specifically, the saving module 414 obtains logs within the acquisition period that are about traffic of equipment identified by the equipment subject type and the subject equipment ID and equipment identified by the storage subject information, and stores the obtained logs in the accumulation DB 405. For example, when the selected entry is the entry Ecs1 of FIG. 12, logs within the acquisition period (the start time: tsc1, the end time: tec1) about traffic (U-plane packets) through the base station 202 (eNB1) to which the terminal 201 (imsi1) is coupled are extracted.

In Step S2004, packet data that corresponds to the extracted logs may be extracted from the U-plane packet data group 401 to be stored in the accumulation DB 405 in addition to the logs. U-plane packet data to be extracted is identified by the time stamp, the terminal-side IP, the server-side IP, the request code, the response code, or other types of information registered in the extracted logs. U-plane packet data that corresponds to quality deterioration can thus be moved from the RRD 404 to the accumulation DB 405 for storage as illustrated in FIG. 8.

The saving module 414 determines whether or not the subject equipment type in the selected entry indicates the terminal 201 (whether or not the subject equipment type has a value “UE”) (Step S2005). In the case where it is not the terminal 201 that is indicated (Step S2005: No), the saving module 414 returns to Step S2002. In the case where the subject equipment type indicates the terminal 201 (Step S2005: Yes), on the other hand, the saving module 414 obtains from the quality information table 424 time-series data of the C-plane failure count of the terminal 201 that is identified by the subject equipment ID (Step S2006). Time-series data of the C-plane failure count is a string of C-plane failure counts of a period that stretches over a given unit time from the time point of the latest data.

Based on the time-series data of the C-plane failure count, the saving module 414 determines whether or not C-plane packet data related to the terminal 201 for which C-plane packets have been identified is to be stored in the accumulation DB 405 (Step S2007). For example, when the time-series data of the C-plane failure count reveals that the C-plane failure count is equal to or more than a given count continuously from the latest data, the saving module 414 determines that there is a problem with the communication quality, and that the C-plane packet data is consequently to be stored.

In the case where the C-plane packet data is not to be stored (Step S2007: No), the saving module 414 returns to Step S2002. In the case where the C-plane packet data is to be stored (Step S2007: Yes), on the other hand, the saving module 414 obtains, from the C-plane packet data group 402 in the RRD 404, C-plane packet data that is in a time zone corresponding to the time-series data of the C-plane failure count and that includes, in the IMSI list, the equipment ID (IMSI) of the terminal 201 relevant to the C-plane failure count. The saving module 414 stores the obtained C-plane packet data in the accumulation DB 405 (Step S2008).

In this manner, C-plane packet data of the terminal 201 that is related to a communication failure can be obtained by embedding an IMSI list in the C-plane packet data group 402. This means that what has caused a communication failure in which terminal 201 can be identified by analyzing C-plane packet data of the terminal 201 related to the communication failure. Thereafter, the saving module 414 returns to Step S2002. When it is found in Step S2002 that no unselected entry is left (Step S2002: No), the saving module 414 ends the series of processing steps.

As described above, according to this embodiment where statistical values of a monitoring subject are saved every unit time, signs of communication quality deterioration can be caught by comparing the statistical values that are newly obtained with past time-series data of the statistical values. Specific logs corresponding to the deterioration are moved from the RRD 404 to the accumulation DB 405 for storage, thereby reducing a storage capacity that is required for the analysis of the cause of deterioration. Specifically, specific logs about quality deterioration can be evacuated to the accumulation DB 405 with the use of the tables 421 to 424 stored in the RRD 404, which has a limited retention period. In short, what is to be stored in the accumulation DB 405 is always identified from among logs remaining in the RRD 404, and accidental erasure in which the RRD 404 erases specific logs about quality deterioration can accordingly be prevented.

The use of the QoE value as one of the statistical values enables the detection apparatus to detect communication quality deterioration even when there is no deterioration event, by objectively identifying a communication quality that is felt by the user. Using the deterioration event count or the failure count as one of the statistical values enables the detection apparatus to detect communication quality deterioration based on the count of deterioration events or failures that occur in traffic.

The log acquisition range in which logs are obtained is set so as to include periods preceding the time of detection of communication quality deterioration and/or periods following the time of detection, and logs within the acquisition range are stored in the accumulation DB 405, thereby making the analysis of communication quality deterioration with time possible. In addition, logs to be obtained can be narrowed down to a sequence in a flow by determining the log acquisition range depending on the duration of the flow in traffic when communication quality deterioration is detected. The analysis of the deterioration cause can accordingly be made efficient.

In the case where the duration of one flow and the duration of another flow overlap, there may be relevance between the flow and the other flow. Logs in the duration periods of the two flows can be obtained at once by including the duration of the other flow in the log acquisition range as well. By referring to the logs of the two flows, the cause of deterioration can be analyzed efficiently.

A burst in an MME can be detected by calculating, as one of the statistical values, the volume of traffic influx to the MME over time. The cause of deterioration with respect to a traffic burst can therefore be analyzed efficiently by storing logs about a burst in the accumulation DB 405.

Logs to be stored can be narrowed down by using the wireless section response qualities between the terminal 201 and the coupled base station 202 when logs are obtained. For example, when the wireless section response quality is equal to or more than a threshold, it is determined that there is no problem with the communication quality of the terminal 201 itself, and that the problem is with the communication quality of the base station 202 to which the terminal 201 is coupled. Accordingly, by obtaining logs related to the base station 202 to which the terminal 201 is coupled from the RRD 404 and storing the obtained logs in the accumulation DB 405, the analysis of the deterioration cause can be narrowed down to logs related to the base station 202 to which the terminal 201 is coupled (including logs about flows in which the base station 202 is coupled to other terminals), which makes the analysis efficient. In the case where the wireless section response quality is less than the threshold, there is a problem with the communication quality of the terminal 201 and, by obtaining logs that are related to the terminal 201 and storing the obtained logs in the accumulation DB 405, the analysis of the deterioration cause is narrowed down to the terminal 201, which makes the analysis efficient.

Logs to be stored can be narrowed down by using the wired section response qualities between the terminal 201 and the coupled server 212 when logs are obtained. For example, when the wired section response quality is equal to or more than a threshold, it is determined that there is no problem with the communication quality of the terminal 201 itself, and that the problem is with the communication quality of the serer 201 which the terminal 201 holds communication to and from. Accordingly, by obtaining logs related to the server 212 which the terminal 201 holds communication to and from the RRD 404 and storing the obtained logs in the accumulation DB 405, the analysis of the deterioration cause can be narrowed down to logs related to the server 212 which the terminal 201 holds communication to and from (including logs about flows in which the server 212 holds communication to and from other terminals 201), which makes the analysis efficient. In the case where the wireless section response quality is less than the threshold, there is a problem with the communication quality of the terminal 201 and, by obtaining logs that are related to the terminal 201 and storing the obtained logs in the accumulation DB 405, the analysis of the deterioration cause is narrowed down to the terminal 201, which makes the analysis efficient.

As described above, the RRD 404 which has a fixed retention period only needs a storage capacity that is necessary for the detection of communication quality deterioration. The storage capacity of the RRD 404 can therefore be reduced by using the logs in the RRD 404 described in this embodiment to detect communication quality deterioration. The storage capacity of the accumulation DB 405 can also be reduced because the accumulation DB 405 only needs a storage capacity for storing specific logs about communication quality deterioration.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. A detection apparatus, including:
a first storage module configured to store logs about traffic between communication apparatus and, when a consumed storage capacity reaches a given level or higher, delete the stored logs starting from an oldest log;
a calculation module configured to refer to specific logs about specific traffic that is related to a subject of communication quality monitoring out of the logs stored in the first storage module, thereby calculating a group of time-series statistical values about communication quality of the monitoring subject;
a detection module configured to compare the group of time-series statistical values calculated by the calculation module with a threshold for communication quality deterioration of the monitoring subject, thereby detecting communication quality deterioration of the monitoring subject; and
a saving module configured to obtain, when communication quality deterioration of the monitoring subject is detected by the detection module, the specific logs from the first storage module and store the specific logs in a second storage module.

2. The detection apparatus according to claim 1, further including a third storage module configured to store distribution information about a distribution of a download time required to download data from a server to a group of terminals, and about a distribution of a download count of the data, and store a reference value for the download time in the distribution information, the server being one of the communication apparatus by which the specific traffic is identified, and the group of terminals being another of the communication apparatus,
wherein the calculation module obtains, from the specific logs, a download time required for one terminal out of the group of terminals that is the monitoring subject to download the data from the server, and, based on the obtained download time and the reference value of the distribution information, calculates the group of time-series statistical values about the communication quality of the one terminal.

3. The detection apparatus according to claim 1, further including a third storage module configured to store distribution information about a distribution of a download time required to download data from a server to a group of terminals, and about a distribution of a download count of the data, and store a reference value for the download time in the distribution information, the server being one of the communication apparatus in the specific traffic, and the group of terminals being another of the communication apparatus,
wherein the calculation module obtains, from the specific logs, a download time required for, out of the group of terminals, a specific group of terminals coupled to a base station that is the monitoring subject to download the data from the server, and, based on the obtained download time and the reference value of the distribution information, calculates the group of time-series statistical values about the communication quality of the base station.

4. The detection apparatus according to claim 1, wherein, when the group of time-series statistical values is time-series statistical values that indicate a communication quality level in the specific traffic, and the time-series statistical value group becomes equal to or less than a threshold and continues to be equal to or less than the threshold for a given length of time since then, the detection module detects that the communication quality of the monitoring subject has deteriorated.

5. The detection apparatus according to claim 1, wherein, when the group of time-series statistical values is time-series statistical values that indicate a communication quality level in the specific traffic, and a proportion of a period in which the time-series statistical value group is equal to or less than a threshold to a given period to a certain time point is equal to or more than a given value, the detection module detects that the communication quality of the monitoring subject has deteriorated.

6. The detection apparatus according to claim 1, wherein, when the group of time-series statistical values is a deterioration event count, which is a count of events where the communication quality has deteriorated in the specific traffic, and a time-series interval sum obtained from the time-series statistical value group is equal to or more than a threshold, the detection module detects that the communication quality of the monitoring subject has deteriorated.

7. The detection apparatus according to claim 1, wherein, when the group of time-series statistical values is time-series statistical values about a burst in the specific traffic, and the time-series statistical value group becomes equal to or more than a threshold and continues to be equal to or more than the threshold for a given length of time since then, the detection module detects that the communication quality of the monitoring subject has deteriorated.

8. The detection apparatus according to claim 1, wherein, when the group of time-series statistical values is time-series statistical values about a burst in the specific traffic, and a proportion of a period in which the time-series statistical value group is equal to or more than a threshold to a given period to a certain time point is equal to or more than a given value, the detection module detects that the communication quality of the monitoring subject has deteriorated.

9. The detection apparatus according to claim 4, wherein the saving module obtains, from the first storage module, out of the specific logs, logs in an interval that is set by using as reference a time point where the time-series statistical value group becomes equal to or less than the threshold, and stores the obtained logs in the second storage module.

10. The detection apparatus according to claim 6, wherein the saving module obtains, from the first storage module, out of the specific logs, logs in an interval that is set by using as reference a time point where the time-series statistical value group becomes equal to or more than the threshold, and stores the obtained logs in the second storage module.

11. The detection apparatus according to claim 10, wherein the saving module obtains, from the first storage module, out of the specific logs, logs in an interval that is set by using as reference a duration of a flow that comprises a time point where the time-series statistical value group becomes equal to or more than the threshold, and stores the obtained logs in the second storage module.

12. The detection apparatus according to claim 2,
wherein, from the specific logs, the calculation module identifies a response delay in a wireless section between the one terminal that is the monitoring subject and a base station to which the one terminal is coupled, and, based on the response delay, calculates a time-series evaluation value that indicates a response quality level of the one terminal, and
wherein, when communication quality deterioration of the one terminal is detected by the detection module, the saving module obtains the specific logs from the second storage module to store the specific logs in the third storage module in a case where the time-series evaluation value that indicates the response quality level in the wireless section is equal to or more than a given threshold, and, in a case where the time-series evaluation value that indicates the response quality level in the wireless section is less than the given threshold, obtains logs related to the base station to which the one terminal is coupled from the second storage module to store the obtained logs in the third storage module.

13. The detection apparatus according to claim 2,
wherein, from the specific logs, the calculation module identifies a response delay in a wired section between the one terminal that is the monitoring subject and a server which the one terminal holds communication to and from, and, based on the response delay, calculates a time-series evaluation value that indicates a response quality level of the one terminal, and
wherein, when communication quality deterioration of the one terminal is detected by the detection module, the saving module obtains the specific logs from the second storage module to store the specific logs in the third storage module in a case where the time-series evaluation value that indicates the response quality level in the wired section is equal to or more than a given threshold, and, in a case where the time-series evaluation value that indicates the response quality level in the wired section is less than the given threshold, obtains logs related to the server from the second storage module to store the obtained logs in the third storage module.

14. A detection method for a detection apparatus configured to detect communication quality deterioration, the detection apparatus including a first storage module configured to store logs about traffic between communication apparatus and, when a consumed storage capacity reaches a given level or higher, delete the stored logs starting from an oldest log, the detection method including executing, by the detection apparatus:
calculation processing of referring to specific logs about specific traffic that is related to a subject of communication quality monitoring out of the logs stored in the first storage module, thereby calculating a group of time-series statistical values about communication quality of the monitoring subject;
detection processing of comparing the group of time-series statistical values calculated by the calculation processing with a threshold for communication quality deterioration of the monitoring subject, thereby detecting communication quality deterioration of the monitoring subject; and
saving processing of obtaining, when communication quality deterioration of the monitoring subject is detected by the detection processing, the specific logs from the first storage module and storing the specific logs in a second storage module.

15. A detection program, which is stored in a memory readable by a processor, the detection program being configured to control the processor to detect communication quality deterioration, the processor being capable of accessing a first storage module configured to store logs about traffic between communication apparatus and, when a consumed storage capacity reaches a given level or higher, delete the stored logs starting from an oldest log,
the detection program being configured to control the processor to execute:
calculation processing of referring to specific logs about specific traffic that is related to a subject of communication quality monitoring out of the logs stored in the first storage module, thereby calculating a group of time-series statistical values about communication quality of the monitoring subject;
detection processing of comparing the group of time-series statistical values calculated by the calculation processing with a threshold for communication quality deterioration of the monitoring subject, thereby detecting communication quality deterioration of the monitoring subject; and
saving processing of obtaining, when communication quality deterioration of the monitoring subject is detected by the detection processing, the specific logs from the first storage module and storing the specific logs in a second storage module.
